(19) United States
(12) Patent Application Publication
(10) Pub. No.: US 2019/0205811 A1
(43) Pub. Date: Jul. 4, 2019

(54) EMPLOYEE TURNOVER AND RETENTION DASHBOARD USING WELL-BEING PROGRAM DATA

(71) Applicant: Limeade, Inc., Bellevue, WA (US)

(72) Inventors: Keith Carpenter, Bellevue, WA (US); Alex Smith, Bellevue, WA (US); Gavin Oxman, Bellevue, WA (US); Julianne Tillmann, Bellevue, WA (US)

(21) Appl. No.: 16/236,133

(22) Filed: Dec. 28, 2018

Related U.S. Application Data
(60) Provisional application No. 62/612,158, filed on Dec. 29, 2017.

(51) Int. Cl. G06Q 10/06; G06Q 10/10; G06K 9/62; G06N 20/20

(52) U.S. Cl. CPC G06Q 10/06393; G06N 20/20; G06K 9/6256; G06Q 10/1053

(57) ABSTRACT

A tool that provides new insight into the turnover between employees who are actively engaged in well-being programs and those who are not. Embodiments of the invention allow attraction and retention of talent to be a key performance measure for an organization's well-being programs. Embodiments of the invention also allow an organization to use its well-being program as a way of demonstrating to employees that the organization cares about their well-being, which is often important for employee satisfaction, productivity, attraction and retention.

### PRIORITY CLAIM

This application claims the benefit of U.S. Provisional Application No. 62/612,158 filed Dec. 29, 2017 and is hereby incorporated by reference in its entirety as if fully set forth herein.

### COPYRIGHT NOTICE

This application is protected under United States and/or International Copyright Laws. © 2018 Limeade, Inc. All Rights Reserved. A portion of the disclosure of this patent document contains material that is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

According to the Center for American Progress (Boushey and Glynn, November 2012, There Are Significant Business Costs to Replacing Employees), businesses spend about one-fifth of an employee's annual salary to replace that worker.

### BRIEF DESCRIPTION OF THE DRAWINGS

FIG. 1 illustrates an example chart of turnover model accuracy.

FIG. 2 illustrates an example user interface of a turnover prediction system.

FIGS. 3A-3S illustrate different views of an example user interface of a turnover prediction system for a first data set.

FIGS. 4A-4S illustrate different views of an example user interface of a turnover prediction system for a second data set.

FIG. 5A-5S illustrate different views of an example user interface of a turnover prediction system for a third data set.

FIG. 6A-6H illustrate different views of an example user interface of a turnover prediction system for a fourth data set.

### DETAILED DESCRIPTION

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

The Limeade® Well-Being Assessment is disclosed in U.S. patent application Ser. No. 15/790,379, entitled SYSTEM AND METHODS FOR A HOLISTIC WELL-BEING ASSESSMENT, filed Oct. 23, 2017, which is a continuation of U.S. patent application Ser. No. 12/463,353 filed on May 8, 2009, which in turn claims the benefit of U.S. Provisional Application No. 61/051,629 filed May 8, 2008 and is a continuation-in-part of U.S. patent application Ser. No. 11/879,030 filed Jul. 12, 2007, which in turn claims the benefit of U.S. Provisional Application Nos. 60/938,996 filed May 18, 2007 and 60/807,178 filed Jul. 12, 2006. All the foregoing applications are hereby incorporated by reference in their entirety as if fully set forth herein.

Embodiments of the invention generally relate to methods and systems that can compute, indicate, and predict employee turnover in a business unit. In a preferred embodiment, a self-service, interactive report allows organizations and/or employers to explore how well-being program (interchangeable with “wellness program” and the like) participation correlate to personnel or employee turnover, with the optionally advantageous feature of providing data to focus retention efforts.

Hereinafter, preferred embodiments of the described system may be collectively referred to as “the Dashboard.” The Dashboard and other embodiments can be utilized by any user, including an employer, organization, department, etc., to determine turnover of any set of employees, workers, volunteers, customers, other people and personnel and the like. Hereinafter, “employer” refers broadly to any user, organization and the like, and “employee” refers broadly to any person or personnel involved with such user or organization.

Embodiments of the present invention may comprise or utilize a special-purpose or general-purpose computer including computer hardware, such as, for example, one or more processors and system memory, as discussed in greater detail below. Embodiments within the scope of the present invention also include physical and other computer-readable media for carrying or storing computer-executable instructions or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special-purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry desired program code means in the form of computer-executable instructions or data structures and which can be accessed by a general purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the invention. The computer executable instructions may be, for example, binaries, intermediate format instructions such as assembly language, or even source code.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Embodiments of the invention can identify low- and high-risk areas for employee turnover within an organization. By identifying these groups, human resource leaders can share best practices from low turnover groups, helping high-risk, costly turnover hotspots across their companies. With the Dashboard as a tool, companies can focus on employee turnover because the cost of replacing an employee can be devastating to budget and morale—and in many cases, turnover is avoidable.

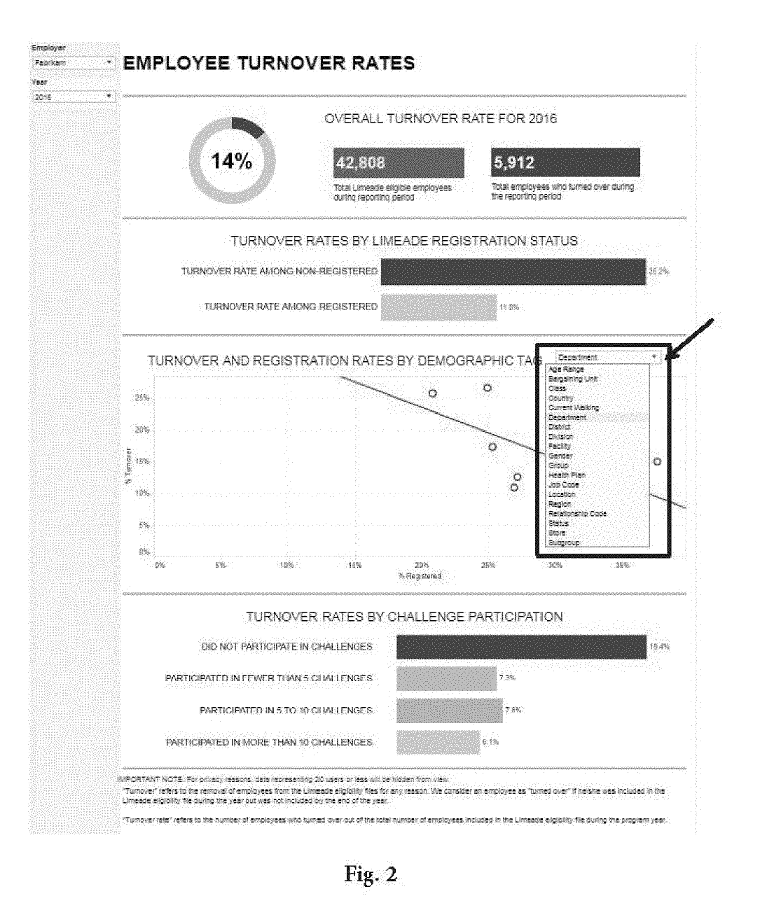

In one or more embodiments of the present invention, employers can review and manipulate interactive charts to understand population turnover trends in, for example, departments, locations, countries, and other categories, by slicing the data by various demographic tags. For example, turnover and well-being program registration rates by demographic tags are illustrated in FIG. 2. Unlike traditional or conventional turnover analyses used now or in the past, the Dashboard considers workforce well-being and not just workforce composition. The Dashboard is a tool that can tie well-being program data to measurable people and business results and analyze the impact of a high-energy, high well-being workforce in a company.

The Dashboard does not require additional third-party data and can directly receive data input from an employer's pre-established well-being program or platform, such as the Limeade® Well-Being Assessment and provide turnover analysis on those employees eligible for and/or participating in the employer's well-being program as well as turnover analysis in relation to employees' well-being program participation.

Data input can include but is not limited to: well-being assessment answers, recommended goals, employee well-being eligibility, well-being dimensions identified as an employee's top strengths and opportunities, and employee participation data. For example, the Dashboard can utilize employee well-being program participation data, which includes valuable information regarding a given employee's level of activity in the well-being program that they are eligible to participate in. Data relating to the employee's level of activity, in turn, can be based on the number of points and levels the user achieved in their program (both metrics may not be standardized across organizations) and employee activity scores (a standardized score showing the extent of employee participation). The Dashboard can then use this data to predict the probability of turnover for an employee, with a return value between zero and one. When this data is aggregated by the Dashboard, the Dashboard can then report the likelihood of turnover, for example, for business units. The employer can focus on reports at the individual level or can focus on broad action to support all employees.

In one embodiment, the calculation of the turnover rate is based on monitoring the list of employees (or a subset of the employees) for changes. Such monitoring can have as little as a 24-hour turnaround in processing updates. The turnover data can include a variety of data points, for example, the reasons for turnover, whether the turnover was voluntary or involuntary, and/or indication of an eligibility and/or status change (e.g., when an employee changes from full-time to part-time and/or other changes relating to such employee's eligibility to participate in the employer's well-being program).

An optionally advantageous feature of the Dashboard is its ability to take in various forms of de-identified data from the well-being program and not only analyze turnover, but also to predict turnover. In another embodiment, machine learning processes are applied to predict turnover.

Data is preferably de-identified and aggregated to protect the privacy of the employees, including their identifiable health and well-being data, from all program administrators and for the employer to comply with the stringent privacy standards of U.S. Health Insurance Portability and Accountability Act of 1996 (HIPAA). Aggregate data can guide the design of positive well-being programs, while remaining committed to protecting employee privacy. Furthermore, the Dashboard can be configured to only show anonymized aggregate data and never show data for groups with fewer than 20 people, for example.

A prototype of one embodiment of the Dashboard using sample Limeade® Well-Being Assessment data was able to predict turnover over a one-year period. The prediction, using the area under the receiver operating characteristic curve (“AUROC”) as a measure of evaluation, resulted in a good indication of probability (meaning, there was predictive power with the data as treated and processed, combined with the chosen algorithm). In this prototype, the prediction formula uses extreme gradient boosting (“XGBoost”) (Tianqi Chen & Carlos Guestrin, XGBoost: A Scalable Tree Boosting System (2016), which is hereby incorporated by reference as if fully set forth herein. Other candidate methods were tested utilizing support vector machines: both a linear and radial kernel, gradient boosted trees, logistic regression with stochastic gradient descent optimization, and adaptive boosted trees.

When analyzing the results of these models, the AUROC proved to be an accurate way to measure the performance of the models. AUROC is a measure of accuracy related to the feature vectors and the algorithm used. AUROC was chosen as the measure of evaluation because of its ability to capture the performance a particular model had on true positives and false positives, which is important when predicting data that is imbalanced or has an outcome contingent on the prediction (e.g., turnover (someone leaving their job)).

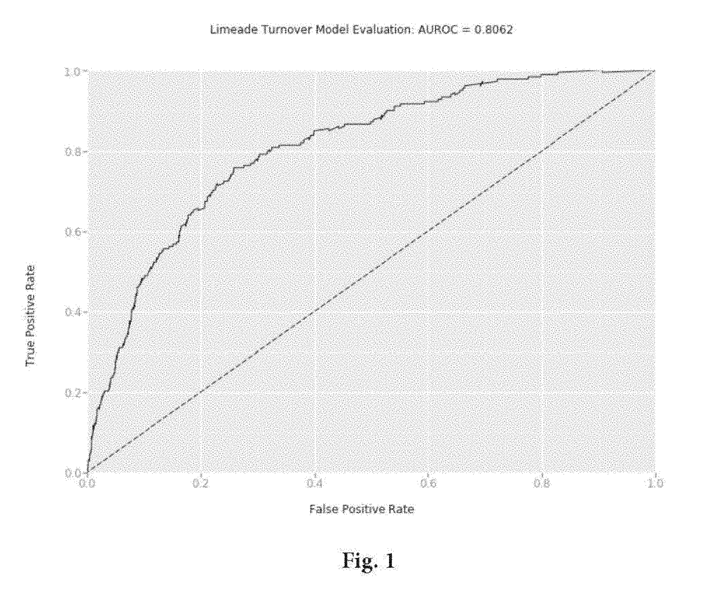

In this prototype, XGBoost was selected as it had the best baseline performance for predictive accuracy. As illustrated in FIG. 1, in this embodiment, the initial XGBoost AUROC score was 0.74; after transformations, normalization, and identifying optimal hyperparameters and early stopping rounds, the final score was 0.81 AUROC, indicating good accuracy.

The ROC curve is created by plotting the true positive rate (TPR) against the false positive rate (FPR) at various threshold settings. The true-positive rate is also known as sensitivity, recall or probability of detection in machine learning. TPR refers to the number of times the model correctly predicted the outcome. The FPR refers to the number of times the model guessed a turnover prediction and was wrong. The AUROC (or AUC) is equal to the probability that a classifier will rank a randomly chosen positive instance higher than a randomly chosen negative one (assuming “positive” ranks higher than “negative”). It is calculated by using the integrals of the various inputs and evaluating their effectiveness at different steps. Effectively, the larger the space between the dotted line in the middle at 0.5 and the curve, the more accurate predictions are.

As discussed, the XGBoost classifier was found to be a superior algorithm in the prototype, which aligns with research conducted by Punnoose and Ajit, who compared several machine learning algorithms in predicting turnover data. Punnoose, R., & Ajit, P., Prediction of employee turnover in organizations using machine learning algorithms: A case for Extreme Gradient Boosting, International Journal of Advanced Research in Artificial Intelligence, 5(9), 22-26 (2016). That study, however, used data from (1) a human resource information system (HRIS), which included such data as key employee demographics, compensation information, and team related data and (2) the Bureau of Labor Statistics (BLS), which included information such as unemployment rate and median household income. In contrast, the Dashboard is able to achieve high predictability using only well-being data, and without any HRIS or BLS data.

Furthermore, in addition to the high predictability, the data from the prototype indicated that both registration and participation in an organization's well-being program correlate with lower turnover rates.

The XGBoost algorithm was chosen because it is a “best-in-breed” algorithm for modeling data in machine learning. In short, it works by building smaller, weak ML models, then using the error of those to build new models that recursively work to minimize the prediction loss function, essentially making an error value as small as possible. This implementation of XGBoost has a stronger regularization component which makes it a strong algorithm for all data science problems.

For model evaluation, an embodiment utilizes a repeated cross-fold validation method to ensure robust results in the model. Due to the imbalanced nature of the data available, an embodiment referenced the area under the receiver operating characteristic curve (AUROC). AUROC is used to assess the accuracy of the test and depends on how well the test distinguishes the two groups being analyzed (Tape, n.d.). AUROC between 0.90 and 1 is considered excellent, 0.80-0.90=good, 0.70-0.80=fair, 0.60-0.70=poor, and between 0.50-0.60 is considered to have failed (Tape, n.d.). Using the SMOTE training set and the decision tree algorithm, the initial model building allowed reaching a benchmark of 0.64 AUROC. We then tested more models on the balanced data set utilizing support vector machines with both a linear and radial kernel, gradient boosted trees, logistic regression with stochastic gradient descent optimization, adaptive boosted trees, and extreme gradient boosting (XGBoost).

The XGBoost algorithm came in with the highest baseline performance, at an AUROC of 0.74. From here, we incorporated feature engineering on the original data set to enhance our performance. After creating dummy variables, transformations, and normalization of continuous features, we then used the XGBoost algorithm to determine performance. We achieved a lift of 0.06 in the AUROC, bringing our evaluation metric up to 0.80 AUROC. To further refine our model, we performed a grid search and found optimal hyperparameters and early stopping rounds, bringing our final model's performance up to a score of 0.81 AUROC, indicating good accuracy.

In another analysis using sample Limeade® Well-Being Assessment data of more than 500,000 employees, who came from U.S. based employers ranging in size from 1,000-20,000 employees in the healthcare, retail and technology sectors, the results indicated: (1) turnover rates were four times higher among employees who weren't registered for a well-being program compared to registered employees; and (2) turnover rates were two times higher among employees with low levels of participation vs. employees with high levels of participation. These findings highlight the value of well-being data for C-level leaders who track business results, specifically turnover. These findings also reinforce the need to understand the role of employee well-being in keeping people engaged and committed. The availability of employee wellness resources improves employee retention, a finding that is echoed by recent research from the Aberdeen Group (Chertok, January 2017, Employee Wellness: Individualizing Productivity).

The Dashboard is a tool that provides new insight into the turnover between employees who are actively engaged in well-being programs and those who are not. Embodiments of the invention allow attraction and retention of talent to be a key performance measure for an organization's well-being programs. Embodiments of the invention also allow an organization to use its well-being program as a way of demonstrating to employees that the organization cares about their well-being, which is often important for employee satisfaction, productivity, attraction and retention.

As a non-exhaustive illustrative example, monitoring and understanding turnover across 1,000 restaurants is complicated but critical to business success. Turnover in the restaurant industry is a challenge, so the Dashboard is invaluable to determine whether there is a correlation between lower turnover and people who participate in well-being programs. In this example, the Dashboard allows a particular restaurant employer to understand opportunities to improve and enhance its position as a great place to work.

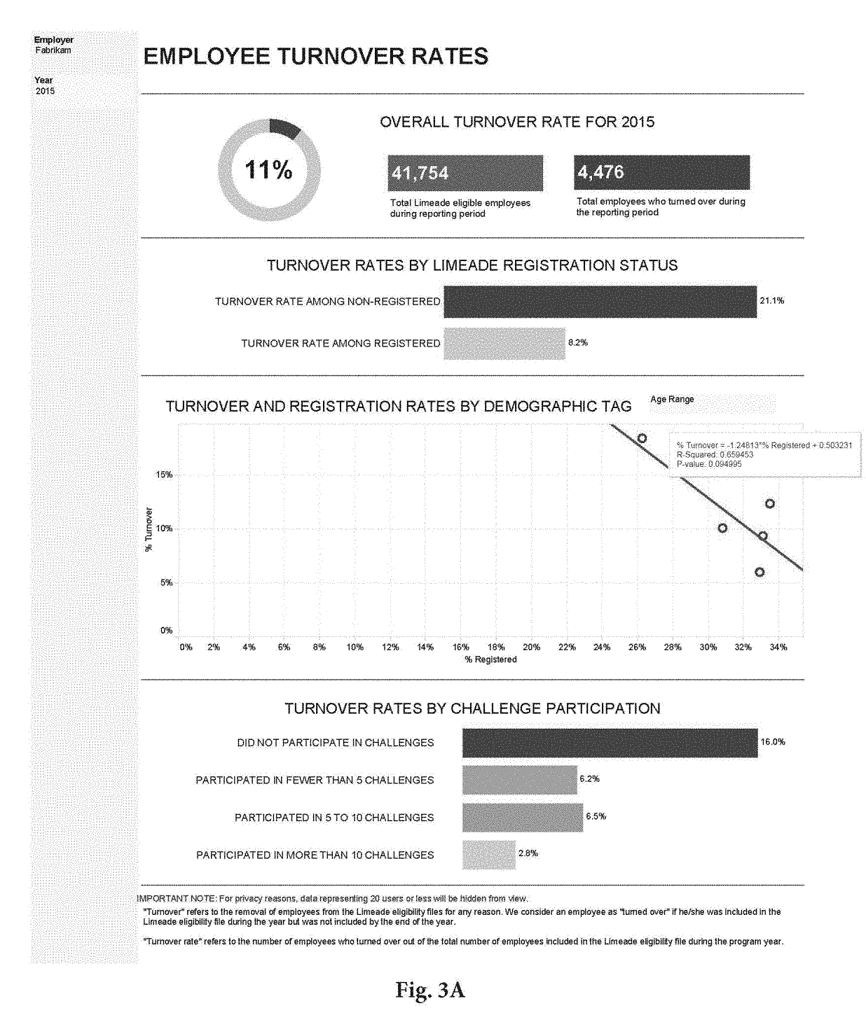

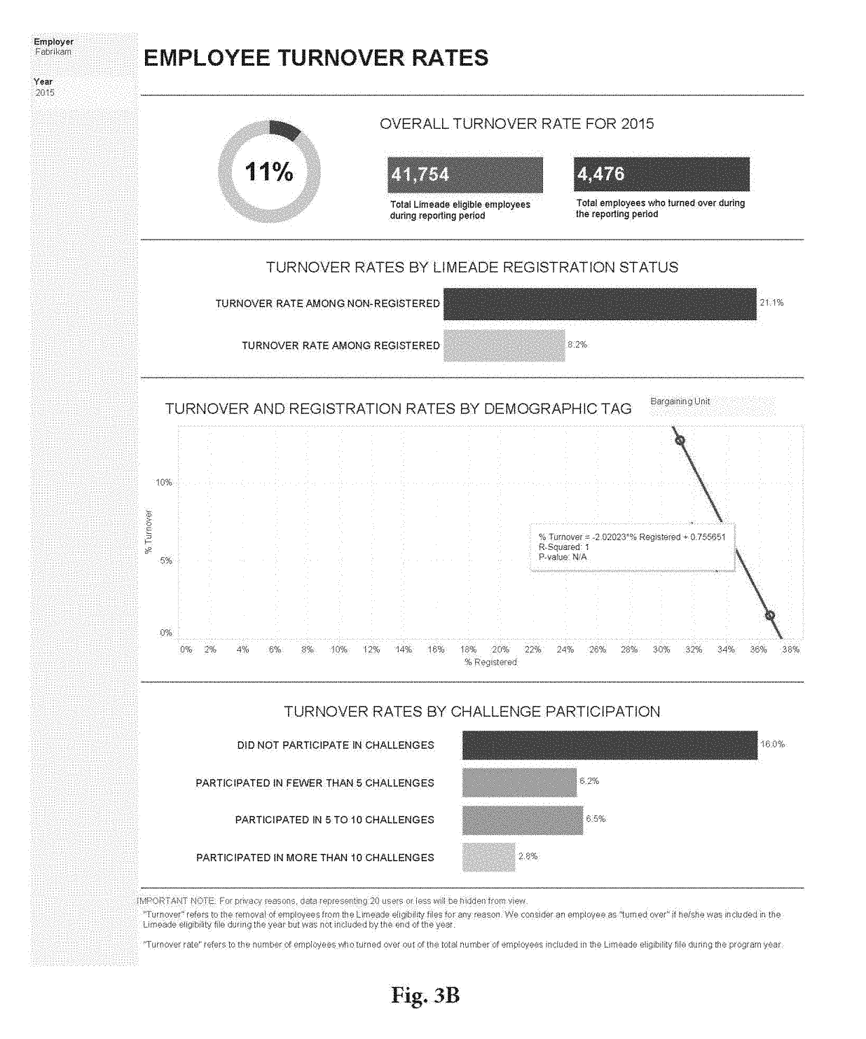

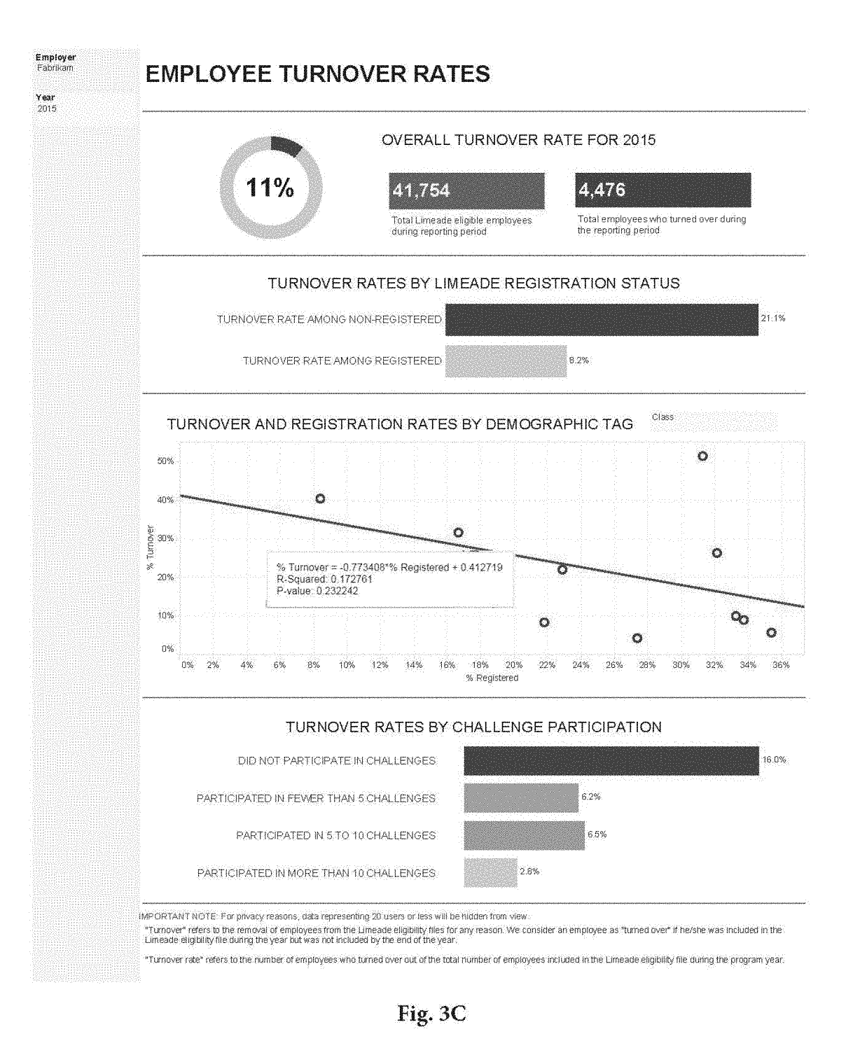

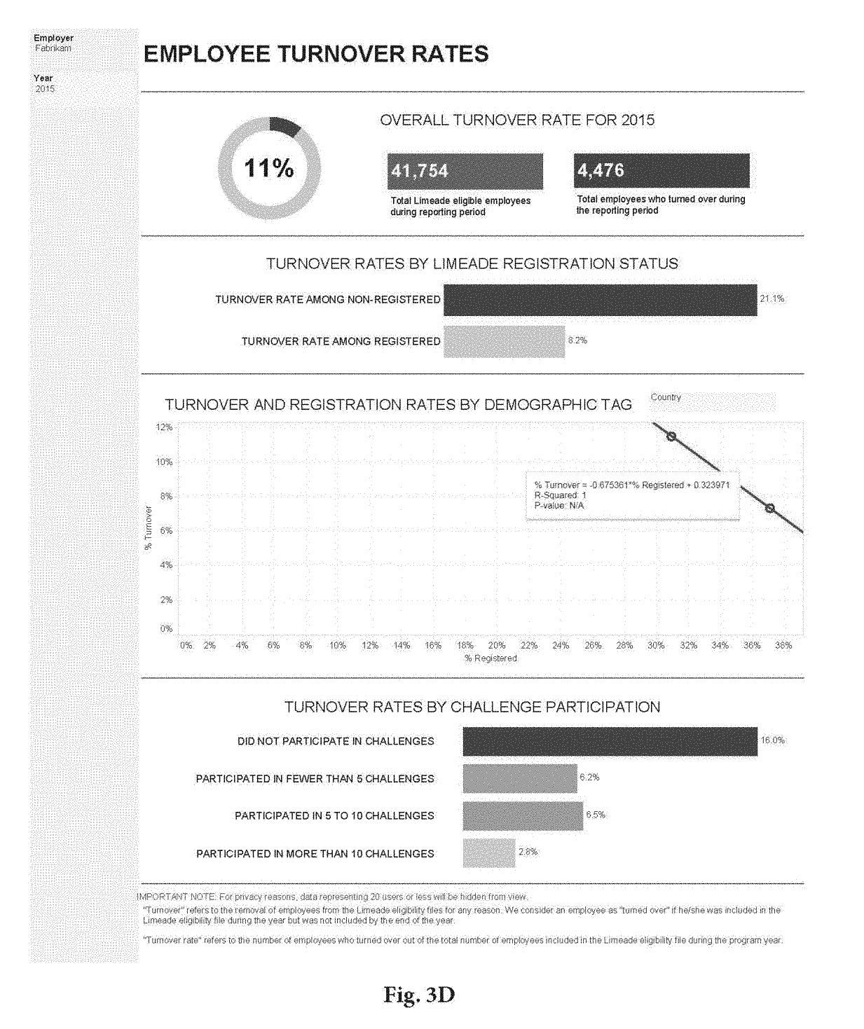

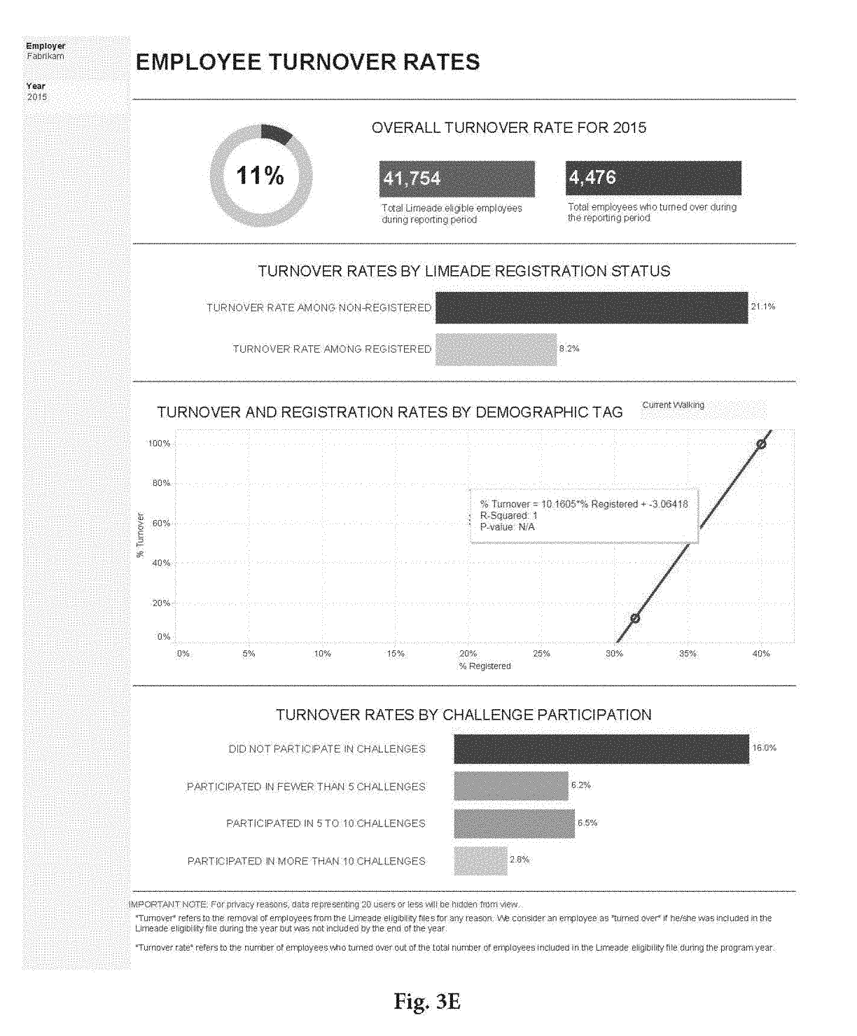

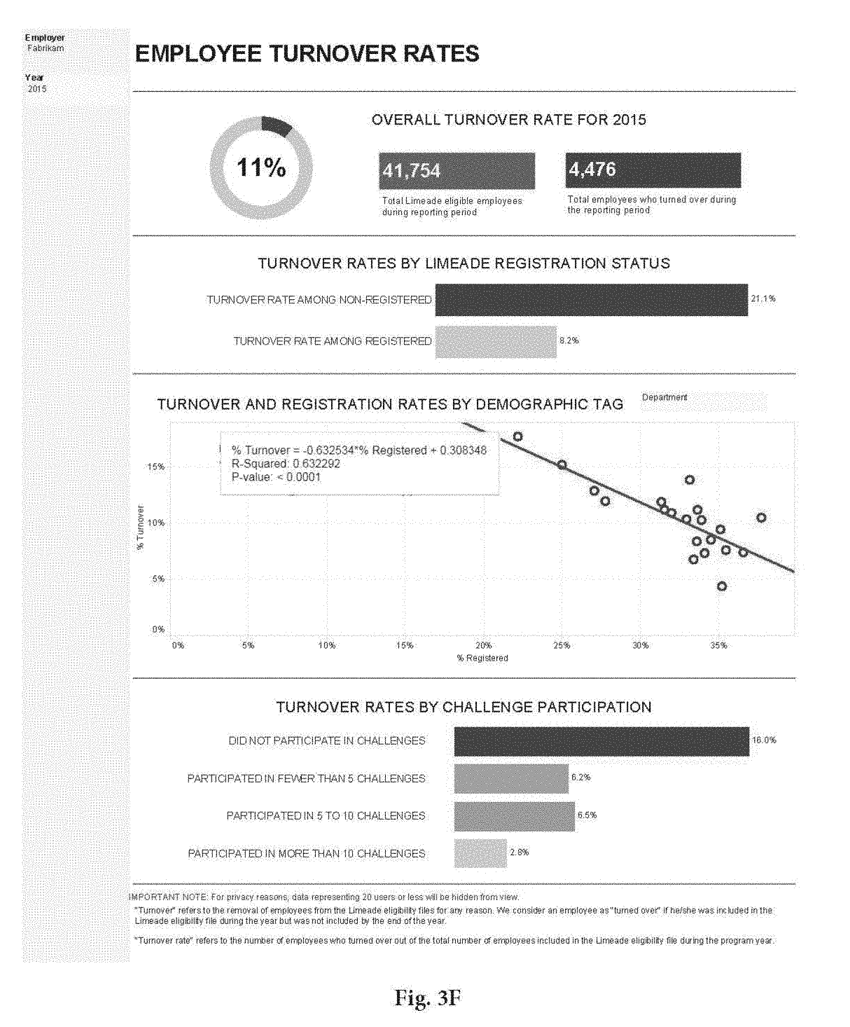

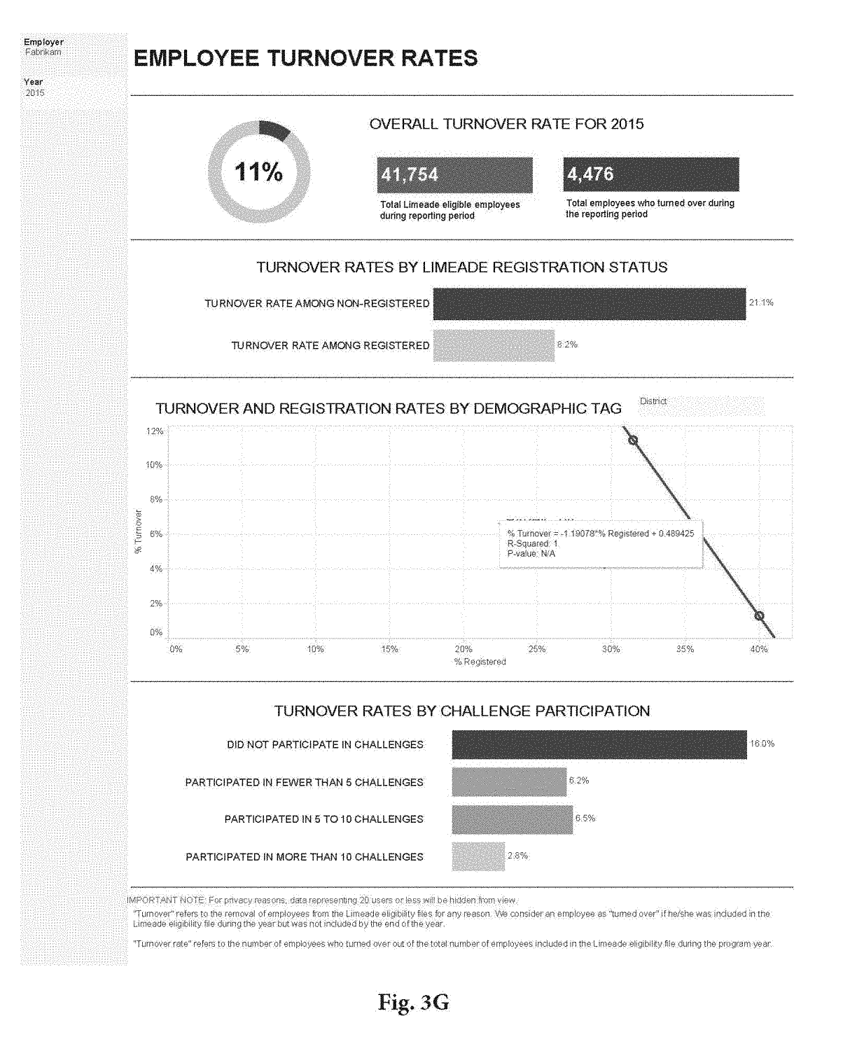

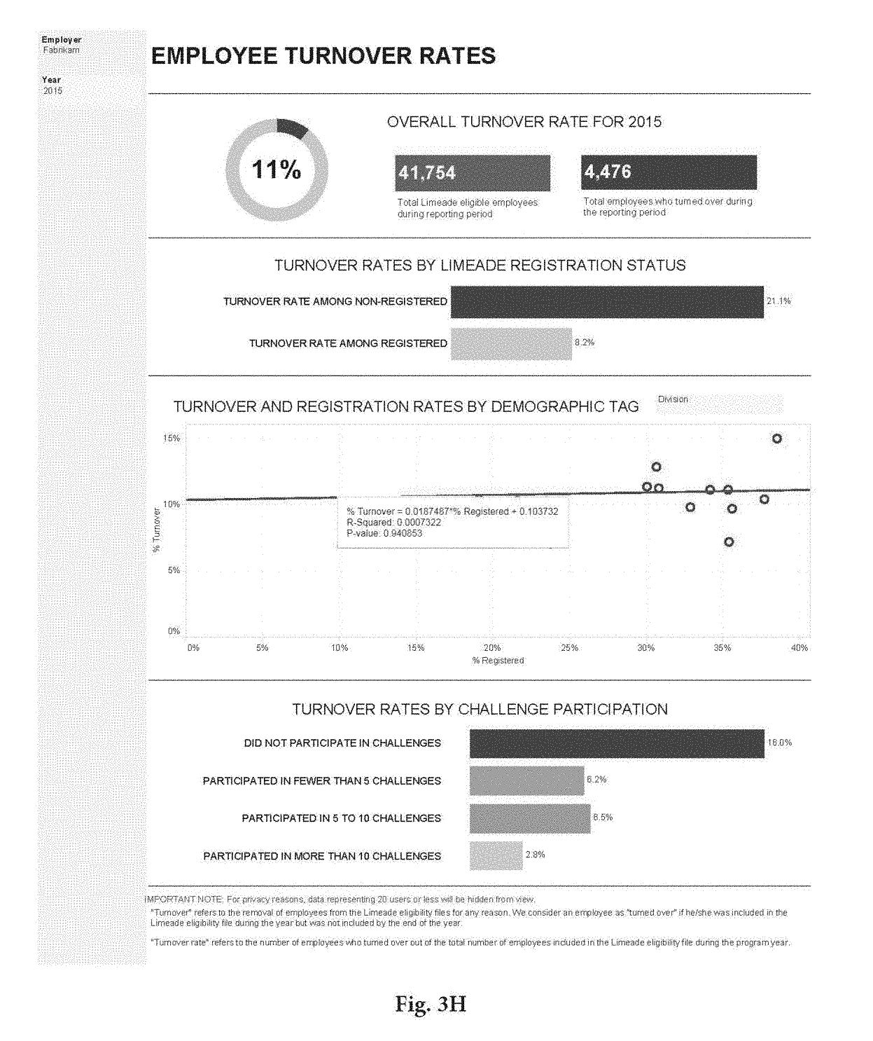

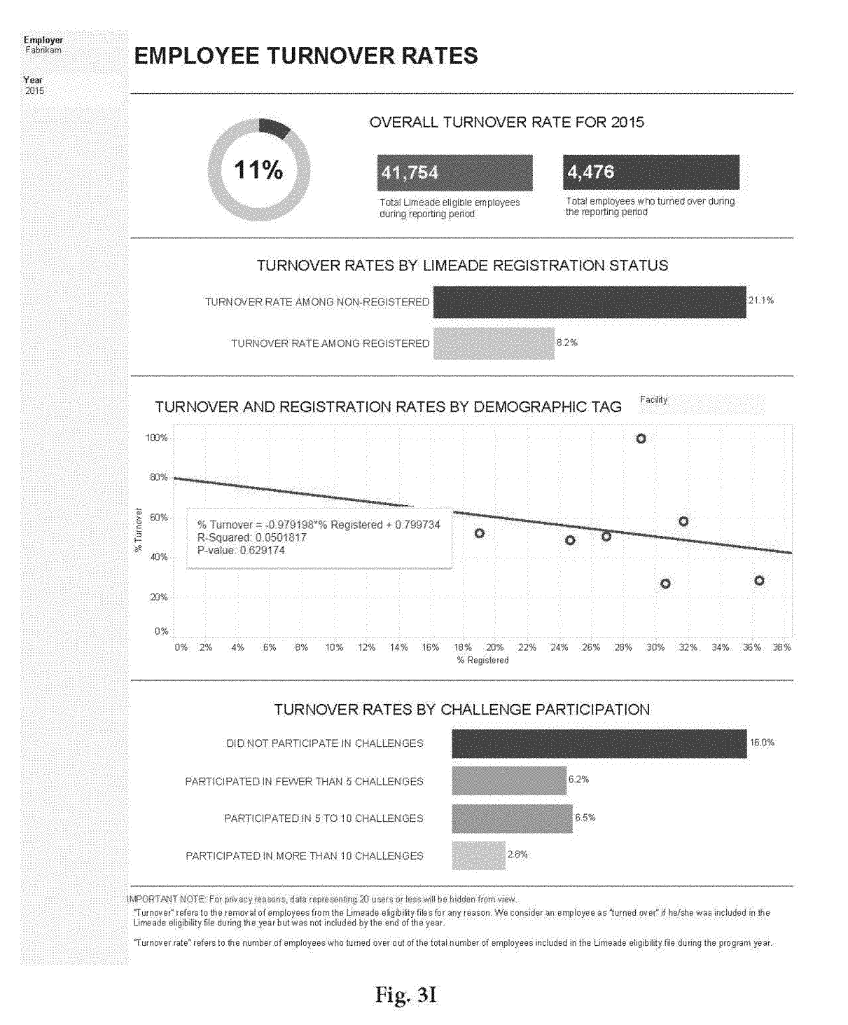

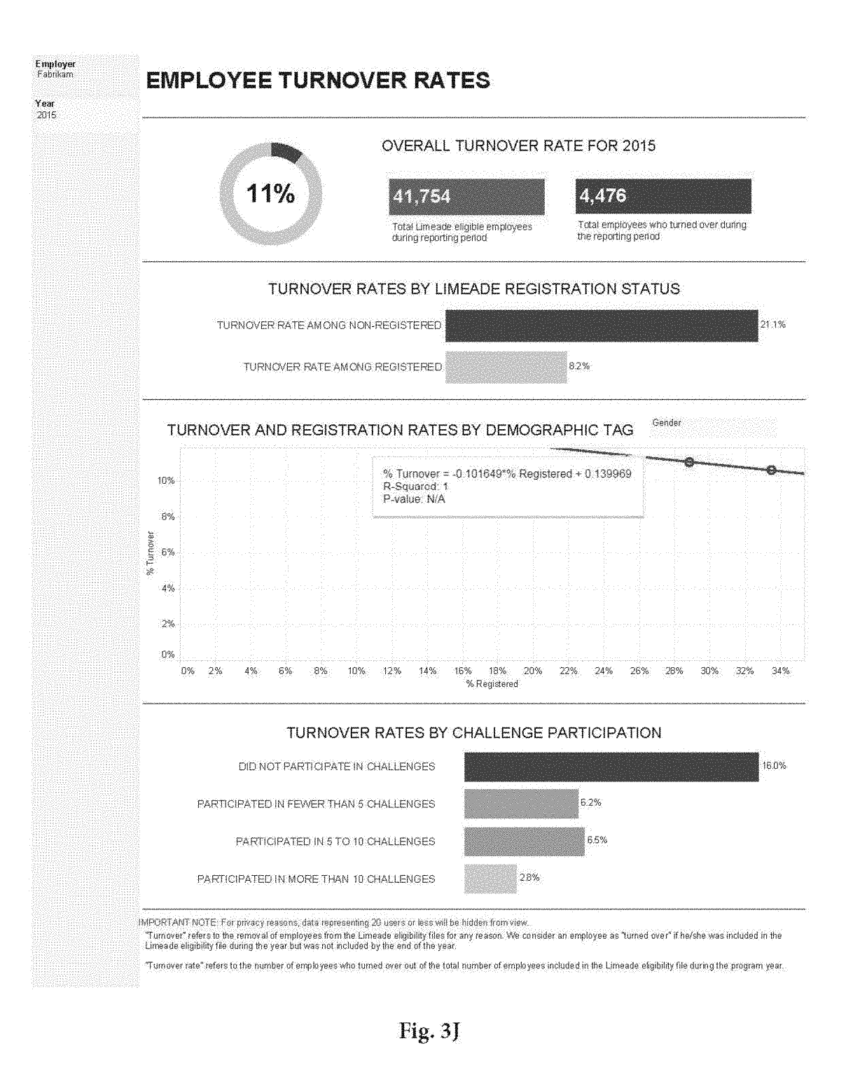

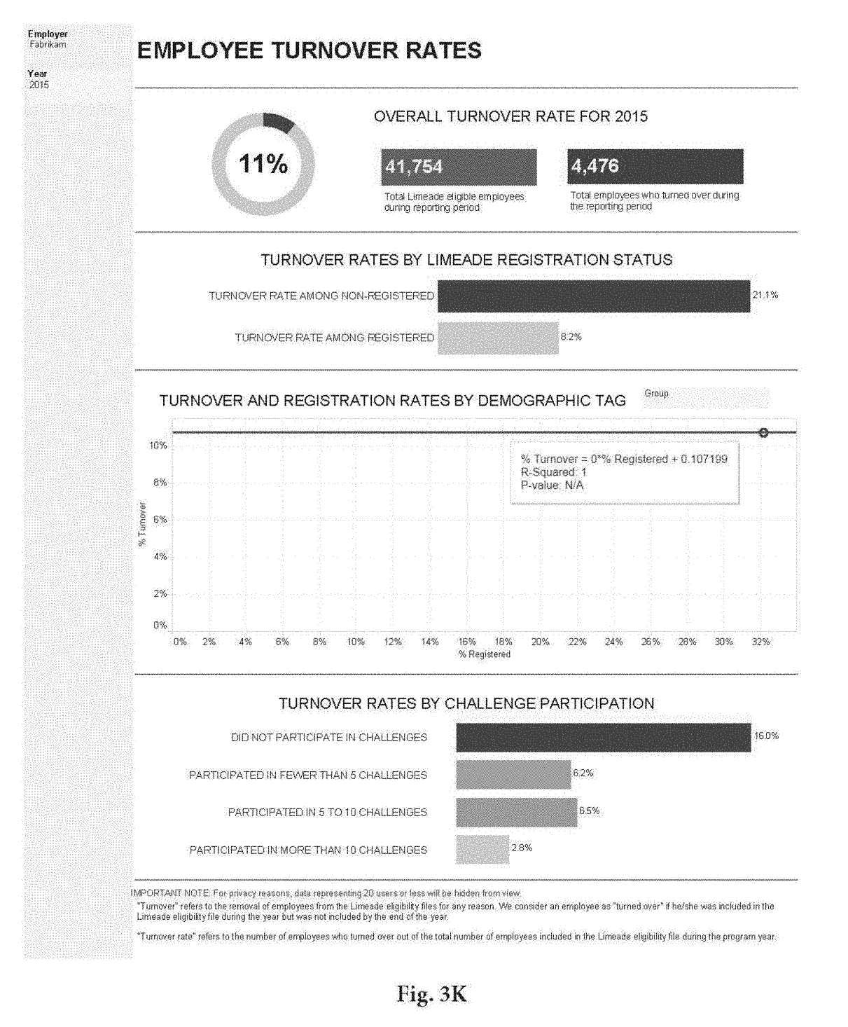

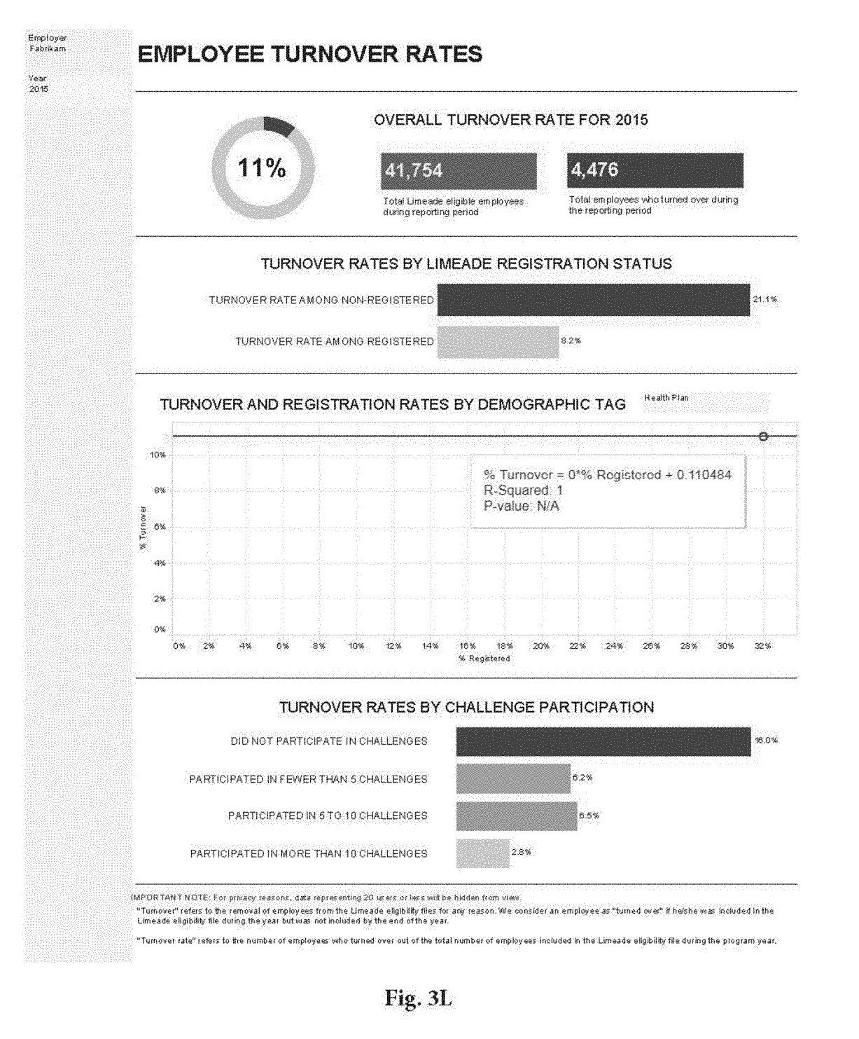

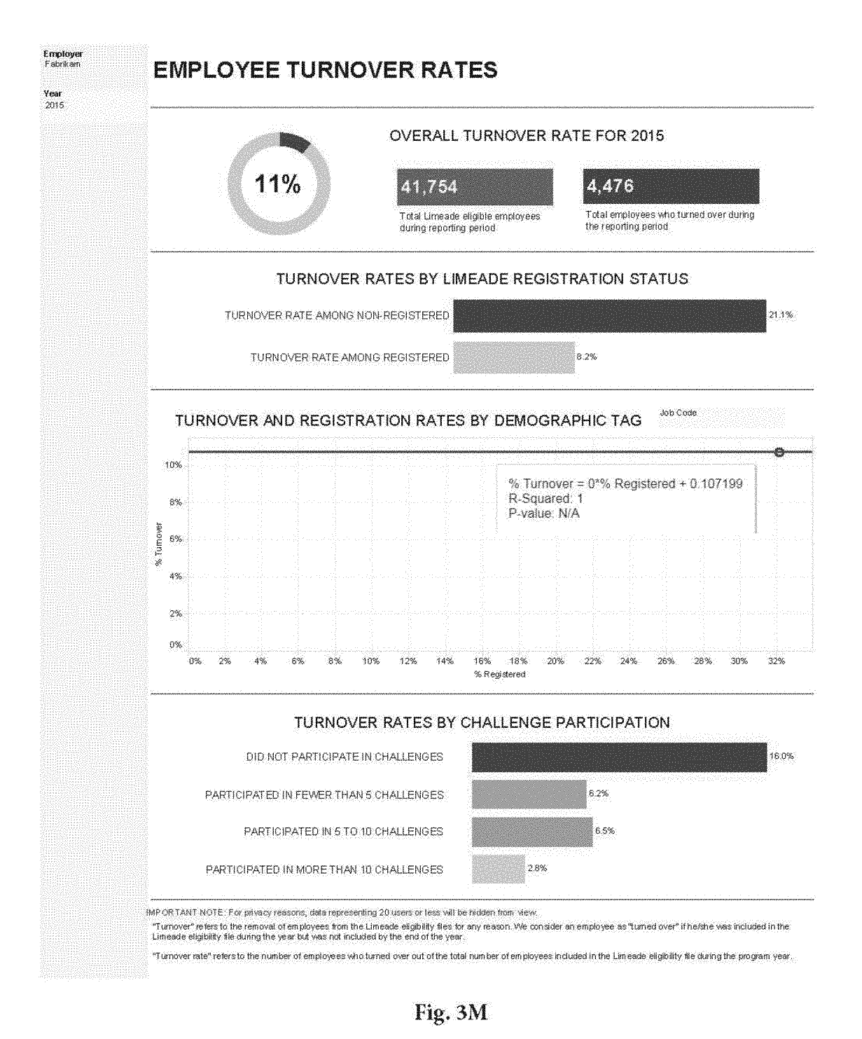

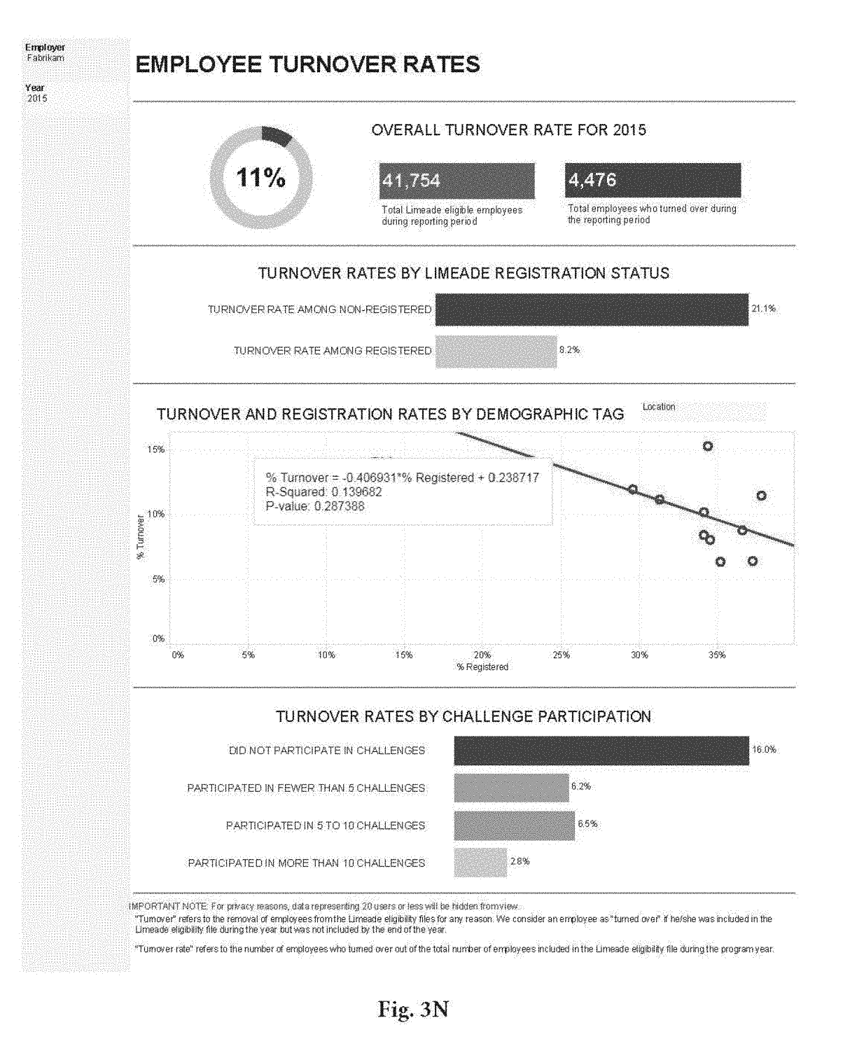

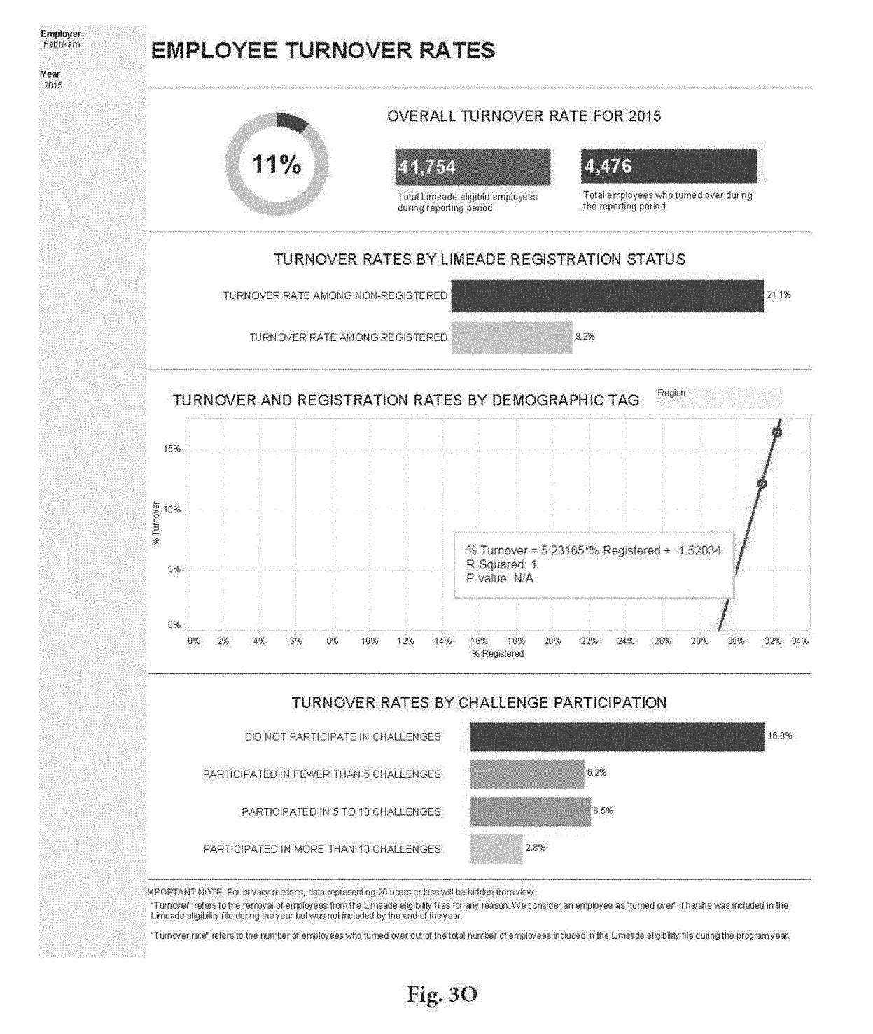

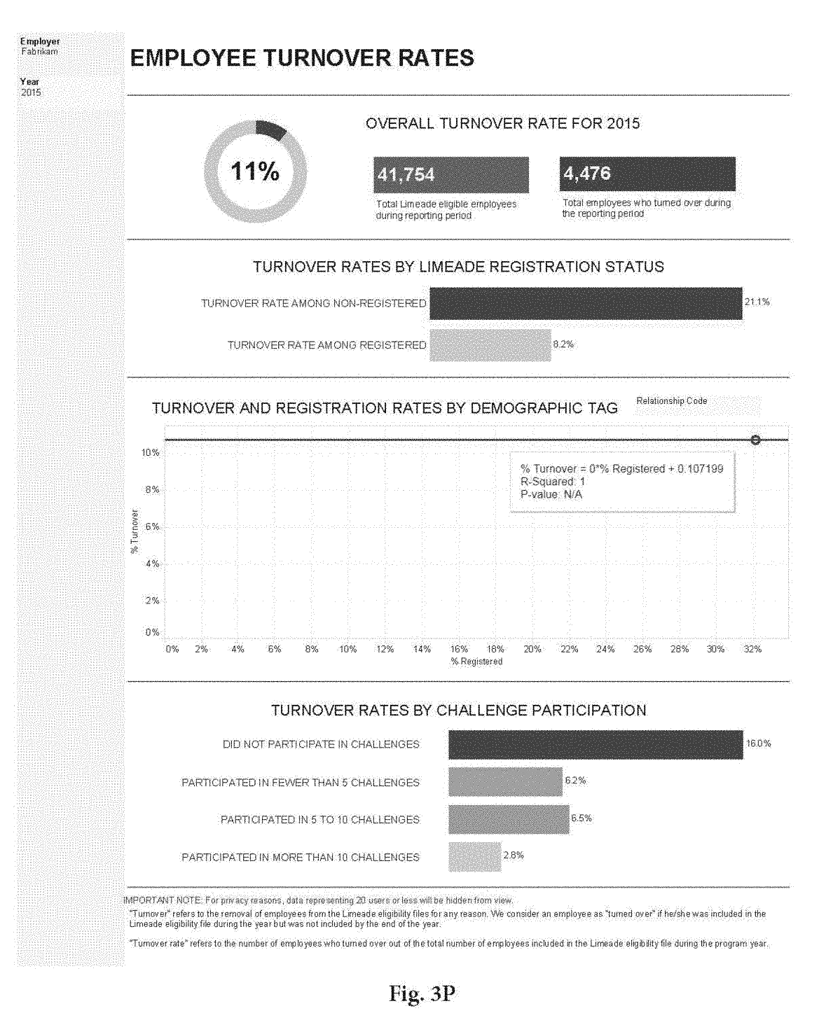

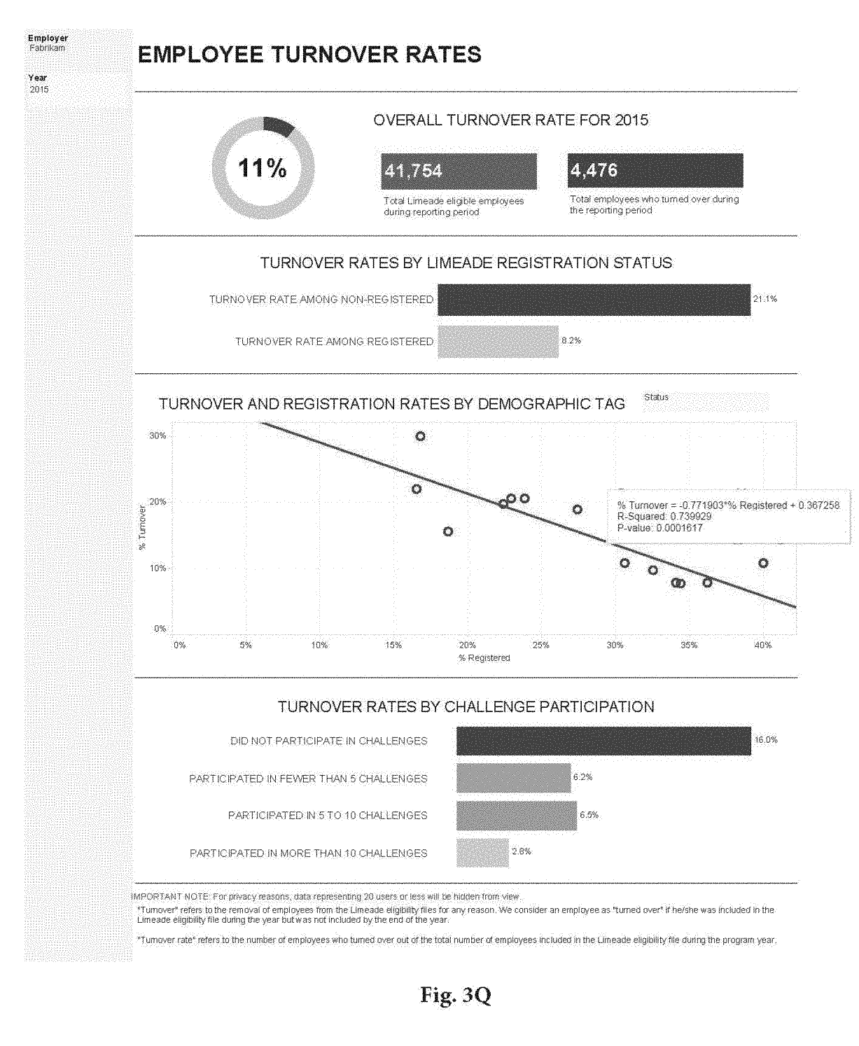

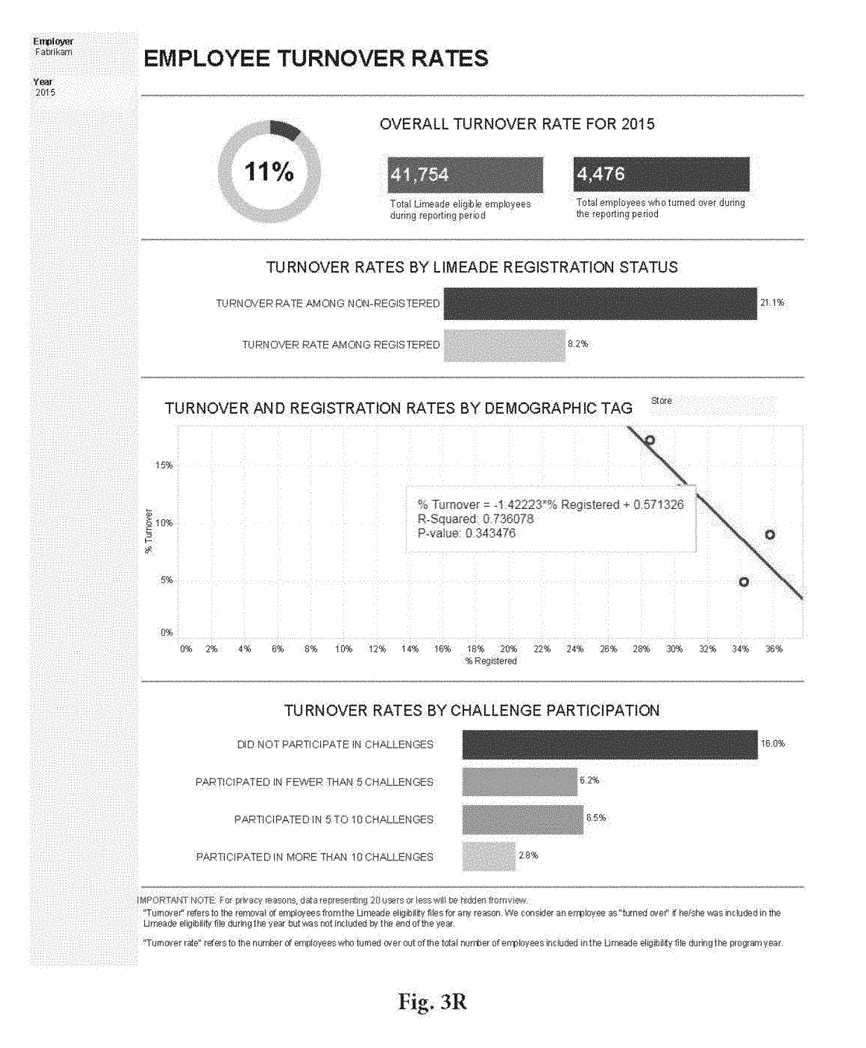

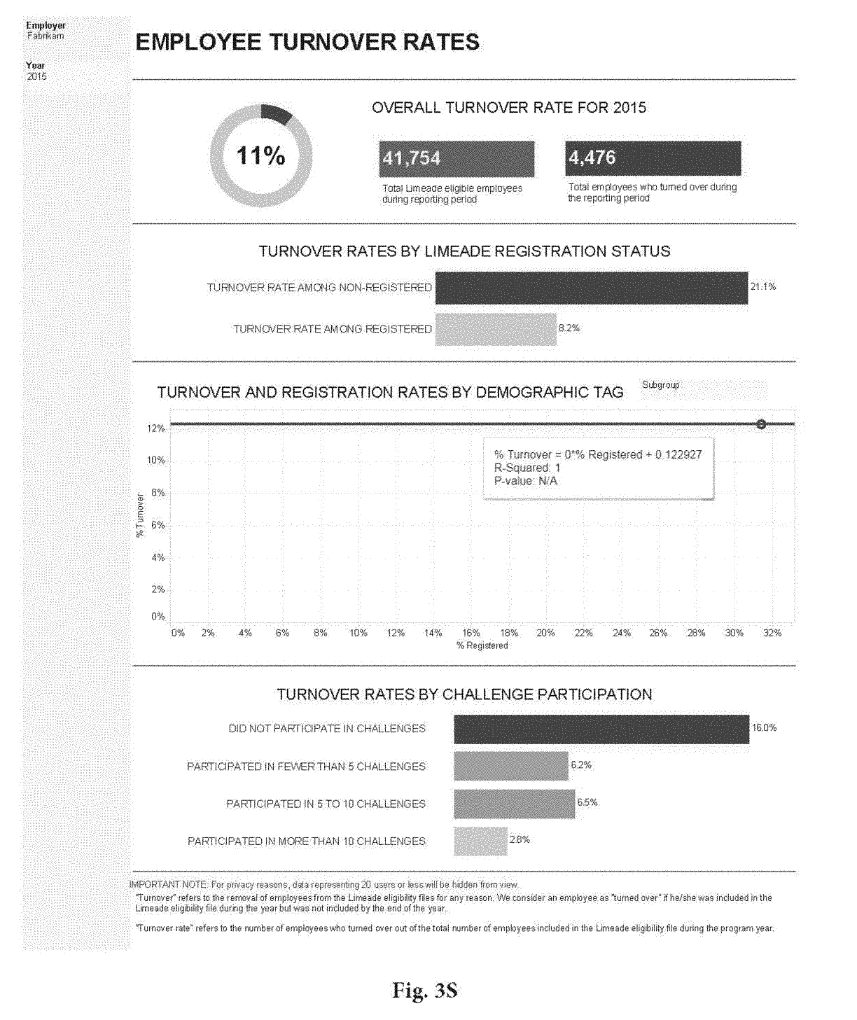

FIGS. 3A through 3S illustrate one embodiment of the Dashboard for turnover information analyzed for, in this example, the Limeade company over year 2015. As used in this embodiment, “turnover” refers to the removal of employees from the Limeade eligibility files for any reason, and “turnover rate” refers to the number of employees who turned over out of the total number of employees included in the Limeade eligibility file during year 2015.

Eligibility files may be provided to the system by a customer/employer and may include a list of employees that are eligible for the program. Being “removed” means that a user existed in the list of eligible users and then was deleted. This is usually a result of a termination of some kind but could also be (less frequently) the result of a person switching to a different department that isn't part of the program-like changing from full-time to part-time and no longer receiving benefits. Calculating the turnover rate is done by monitoring the eligibility list of employees for changes, with as little as a 24-hour turnaround in processing updates.

As illustrated in FIG. 3A, the overall turnover rate for year 2015 was observed to be 11%. There was a total of 41,754 Limeade eligible employees during year 2015, and a total of 4,476 employees were observed to have turned over during year 2015.

As illustrated in FIG. 3A, the Dashboard can also provide information about turnover rates in relation to wellness program registration status. There was a 21.1% turnover rate among non-registered employees, and a lower 8.2% turnover rate among registered employees.

As illustrated in FIG. 3A, the Dashboard can also provide a more detailed graph depicting turnover percentage vs. registration percentage by demographic tag. FIG. 3A shows a graph by the demographic tag “Age Range.”

As illustrated, each point is a defined user group in a population. If “class” is selected from the drop-down box, each dot represents the total number of people associated with each “class” defined in their eligibility data. The trend line is an automatically-generated trend line from Tableau (as well as the R-squared and P value) and is meant to show a directional correlation between the points. When the line is pointing downwards, this suggests that groups that use Limeade more have lower turnover. Percent turnover is the percentage of employees in each group who have a termination date in the Limeade program data (out of the total number of eligible employees defined in the eligibility file). Termination date is defined when companies stop paying for a specific employee's Limeade license each year. Percent registered represents the percentage of employees who signed up for Limeade (out of the total number of eligible employees defined in the eligibility file).

As illustrated in FIG. 3A, the Dashboard can also show turnover rates by the employees' percentage participation in challenges (e.g., activities/tasks/goals) within the wellness program. There was a turnover rate of 16.0% for employees who did not participate in challenges. There was a turnover rate of 6.2% for employees who participated in less than 5 challenges. There was a turnover rate of 6.5% for employees who participated between 5-10 challenges. There was a turnover rate of 2.8% for employees who participated in more than 10 challenges.

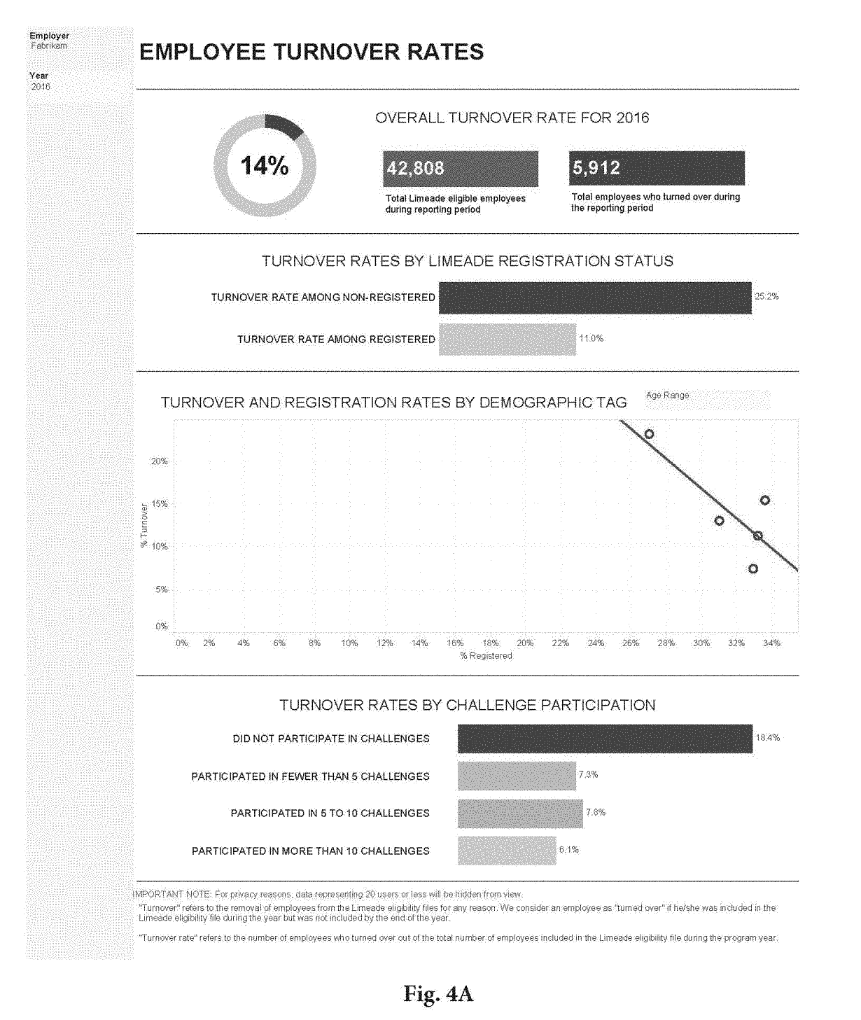

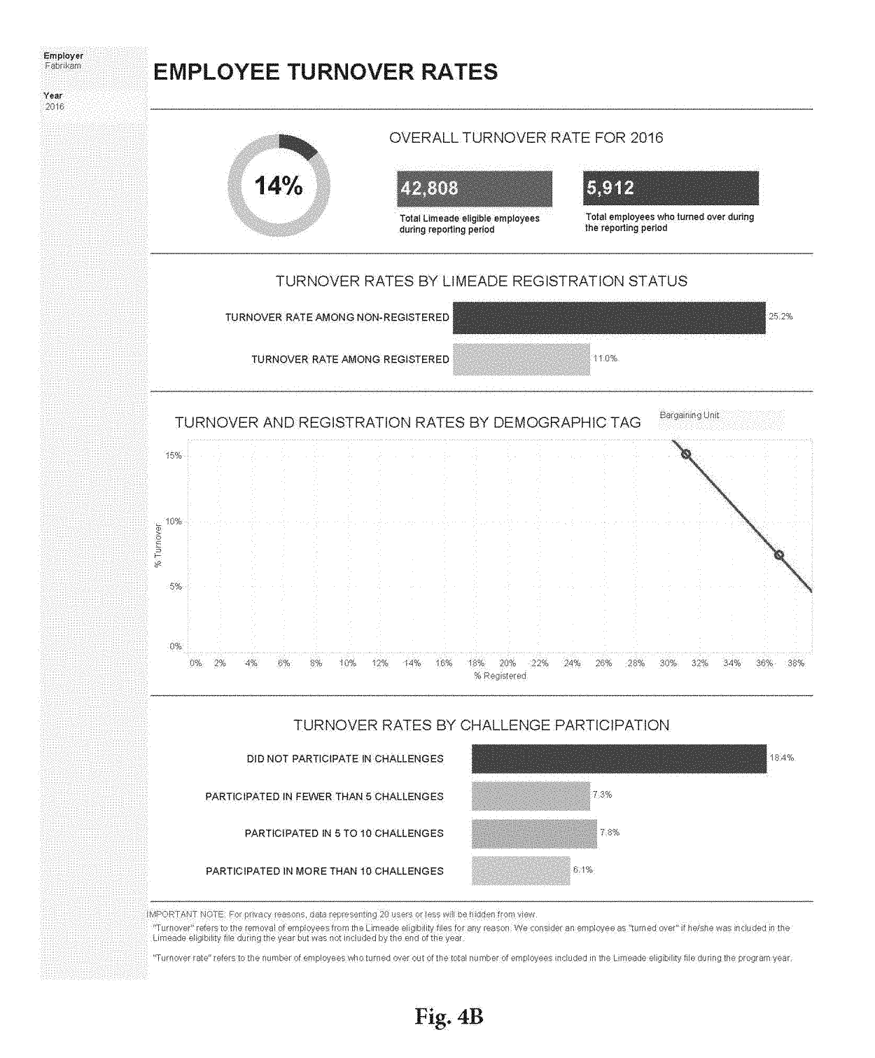

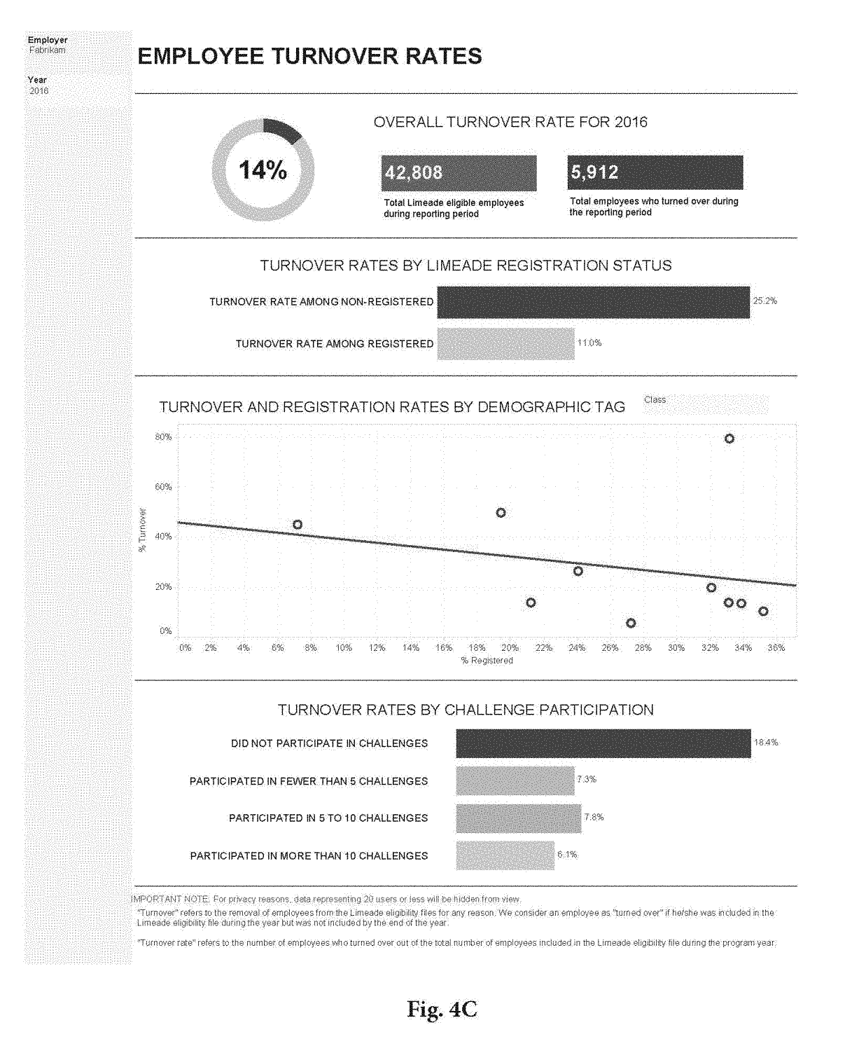

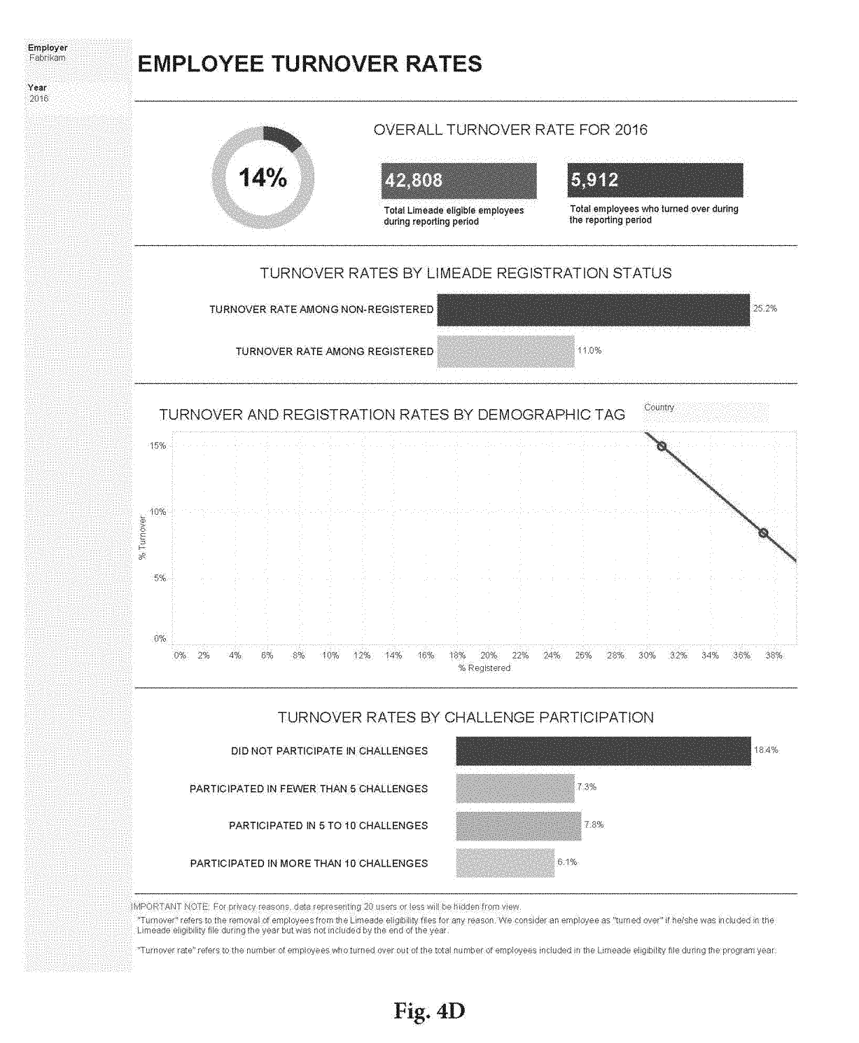

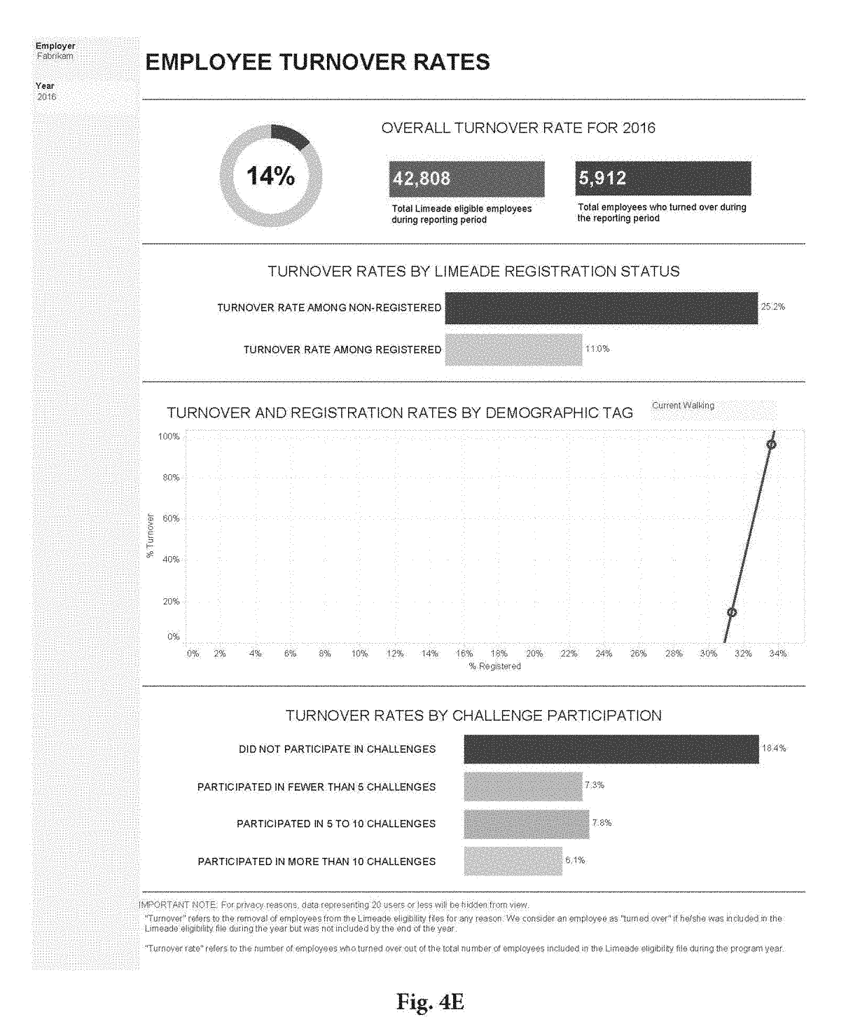

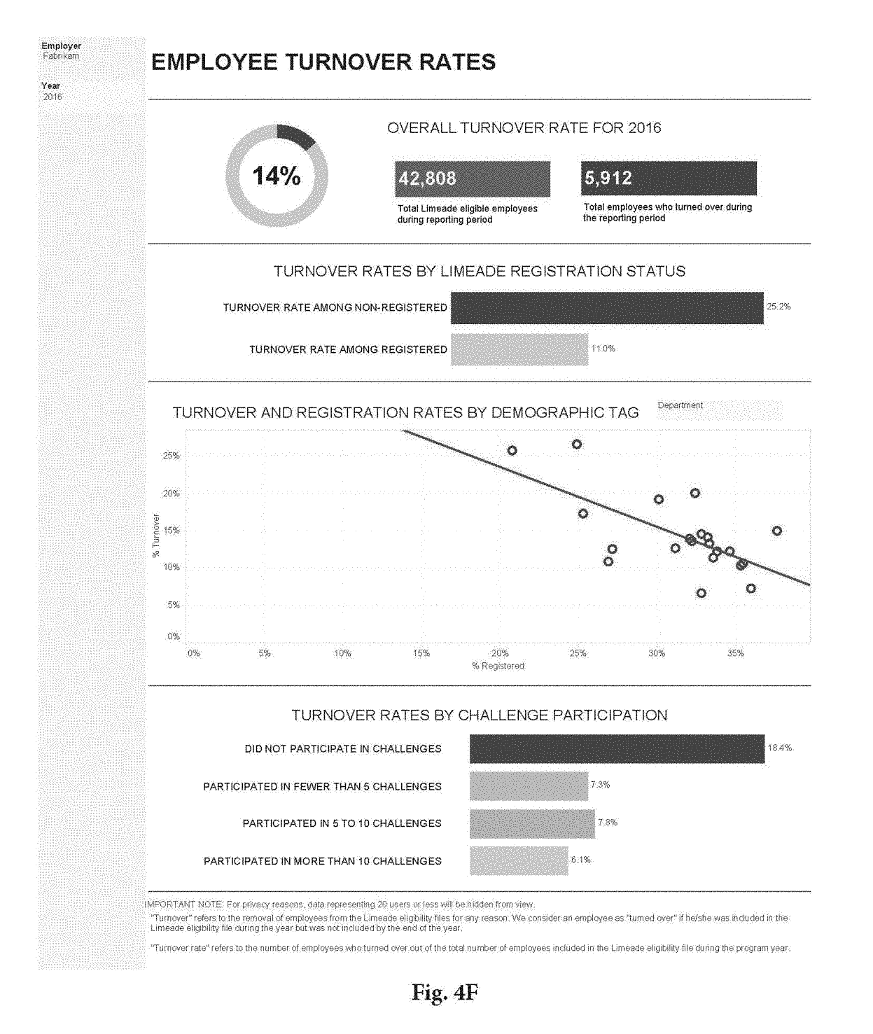

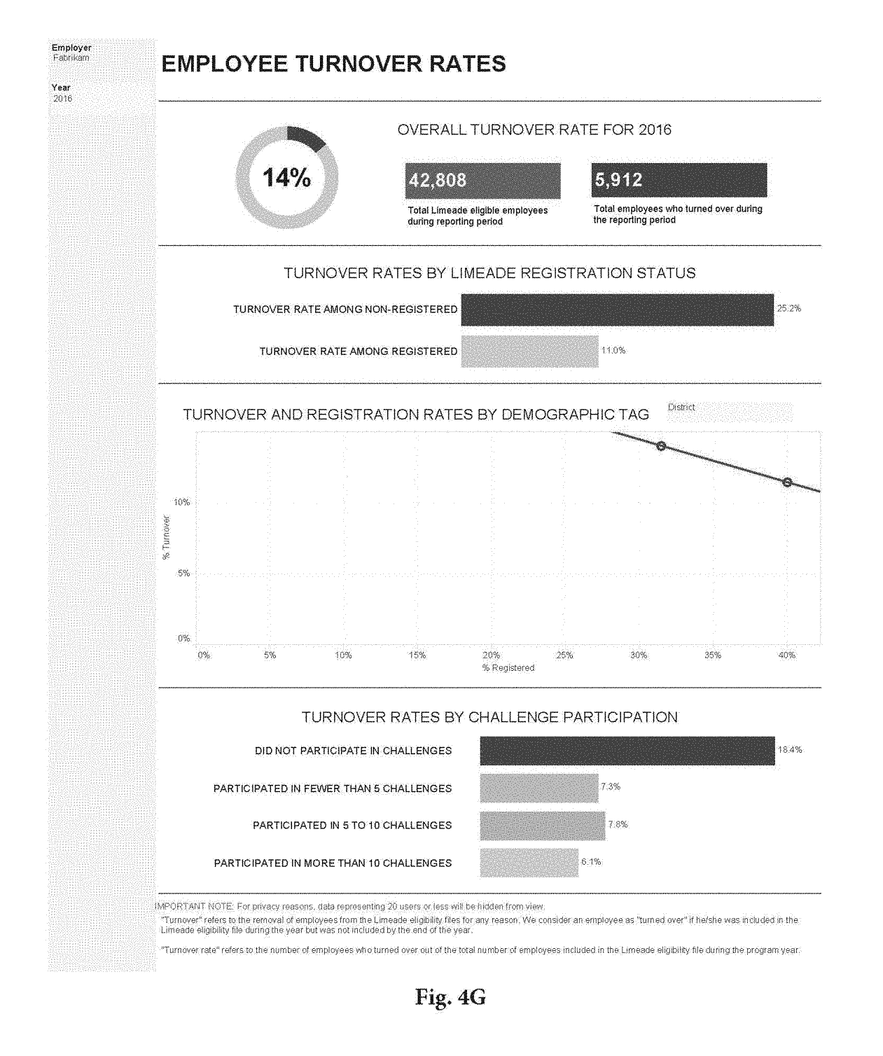

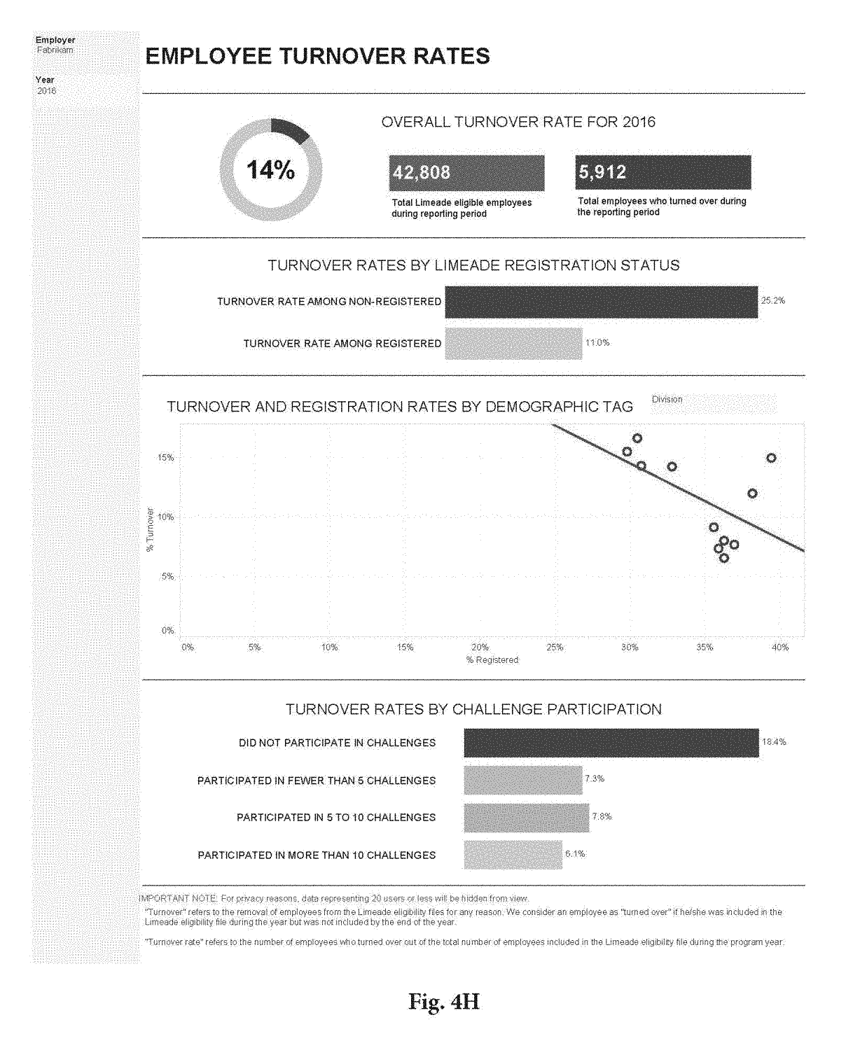

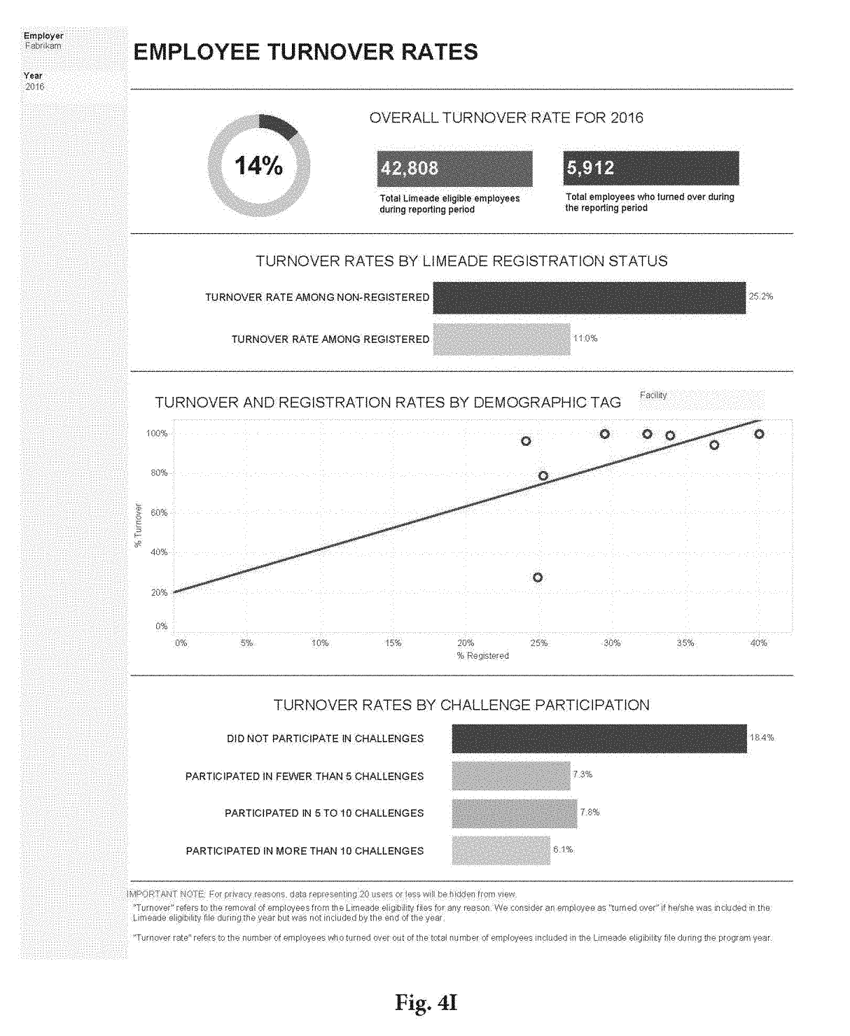

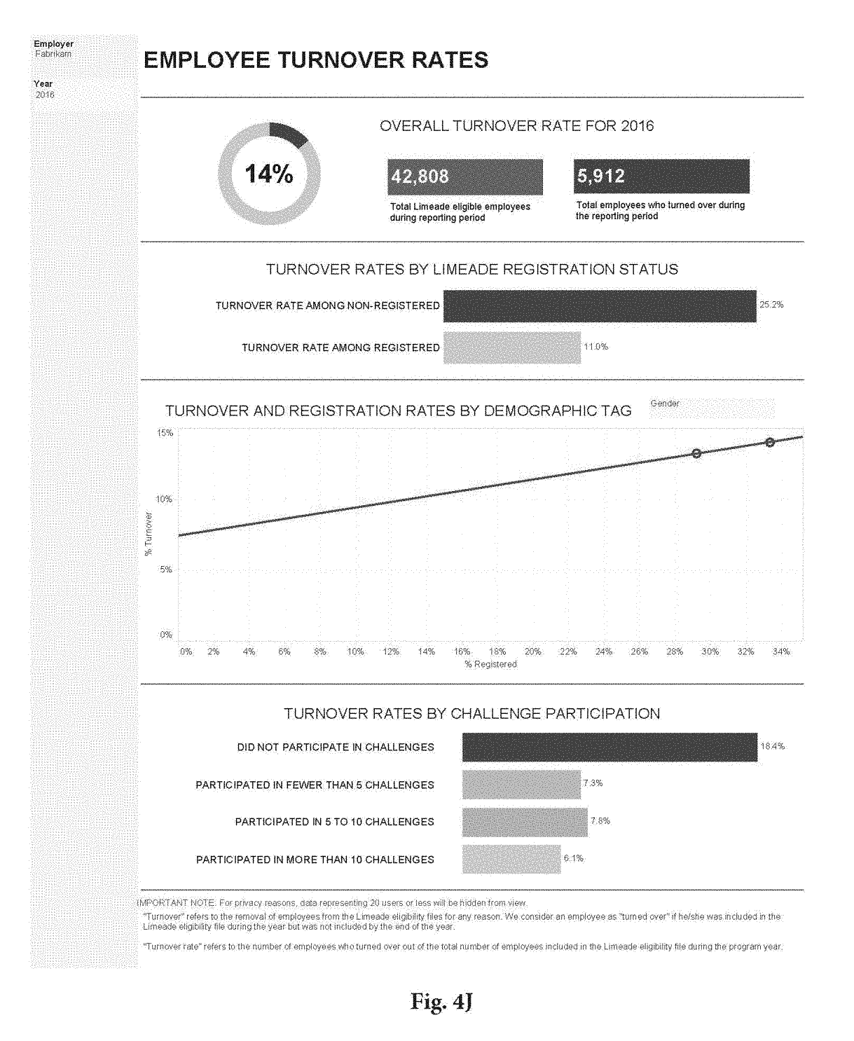

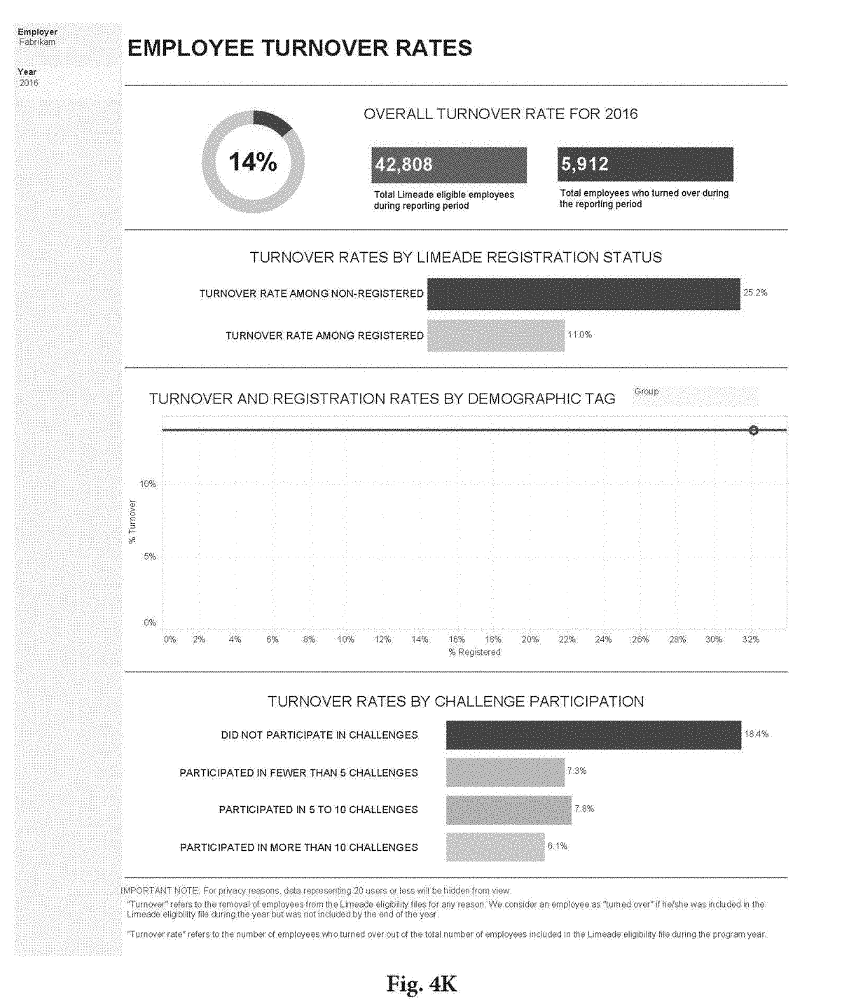

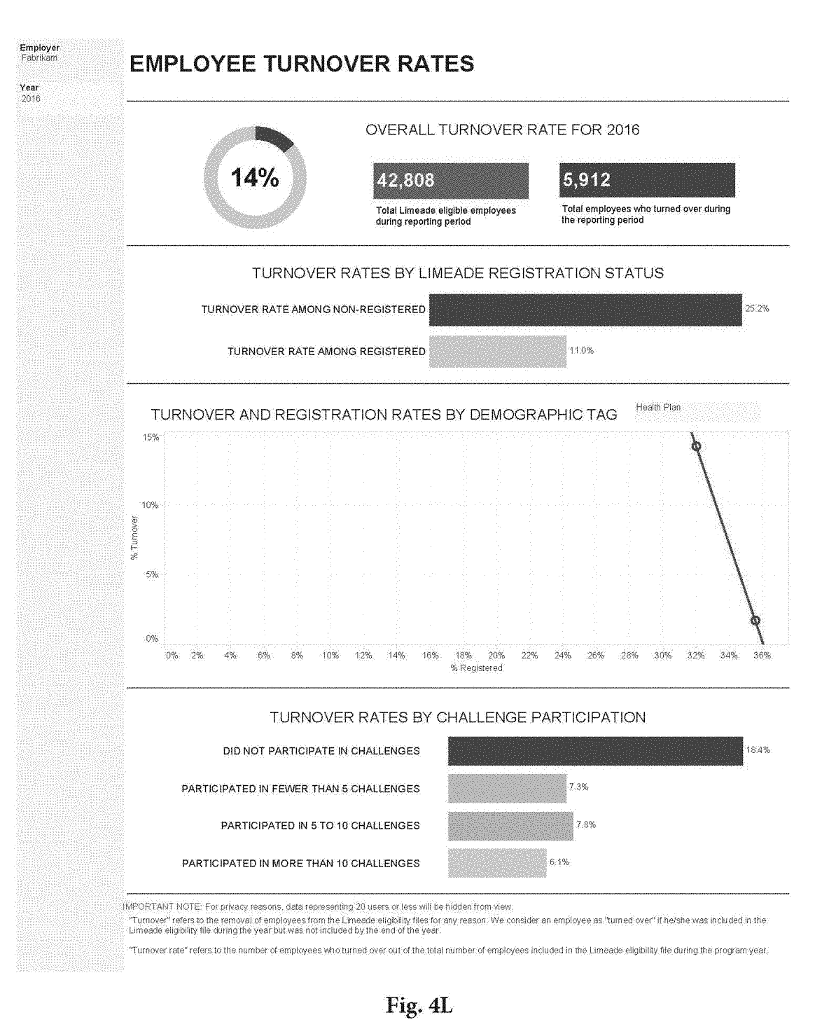

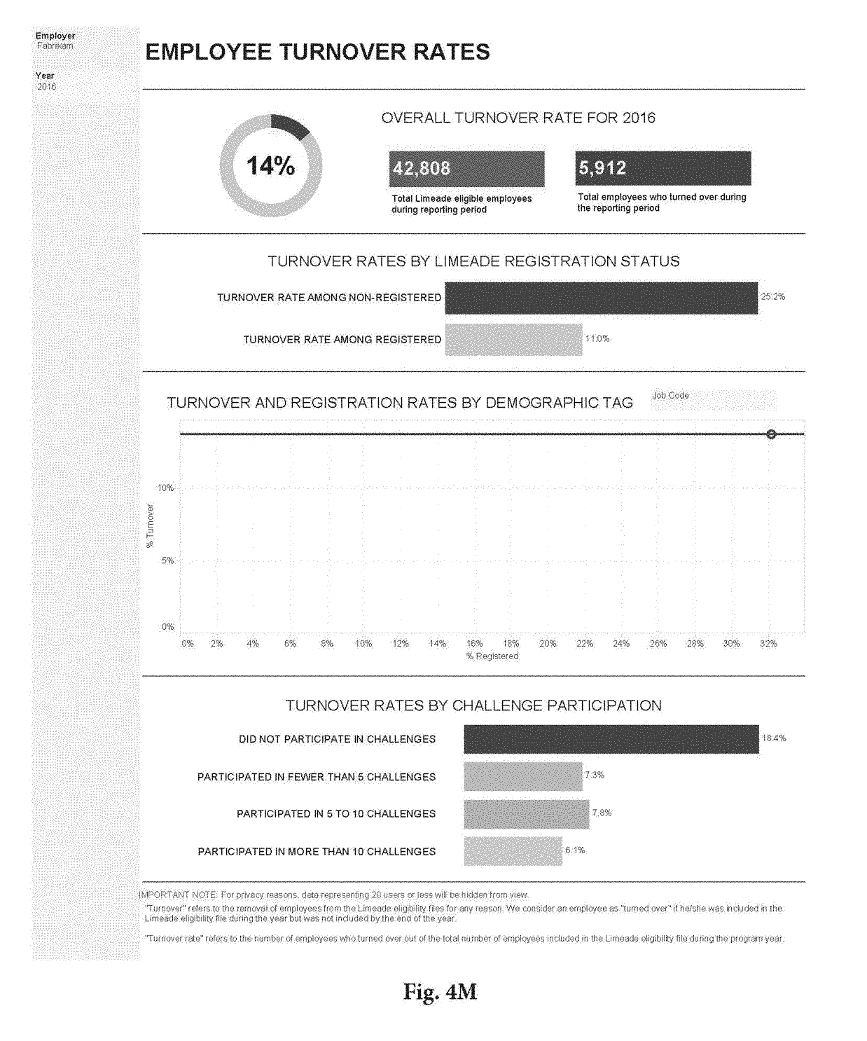

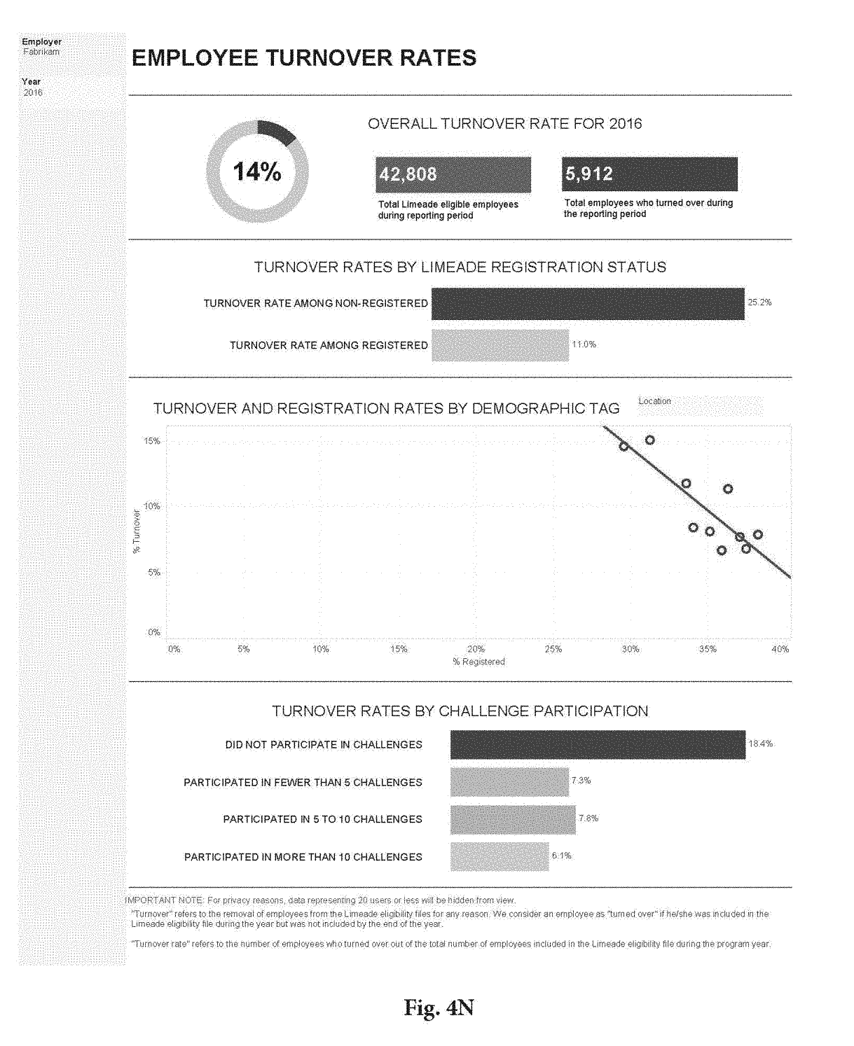

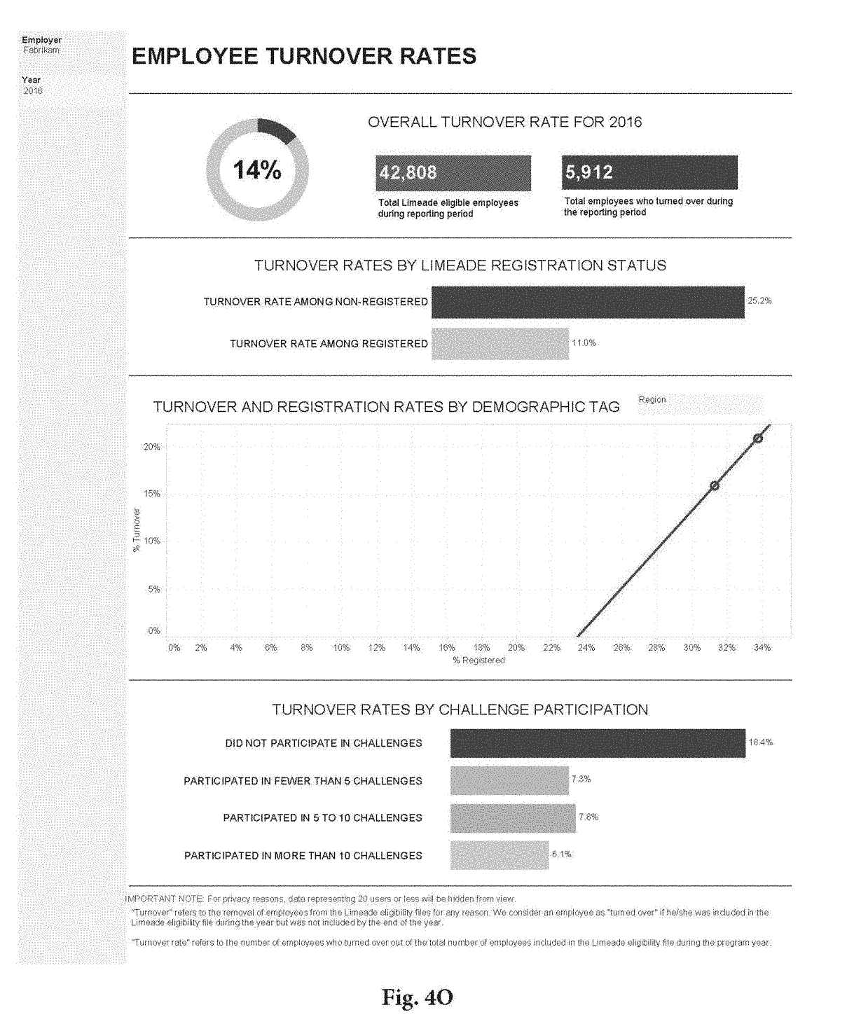

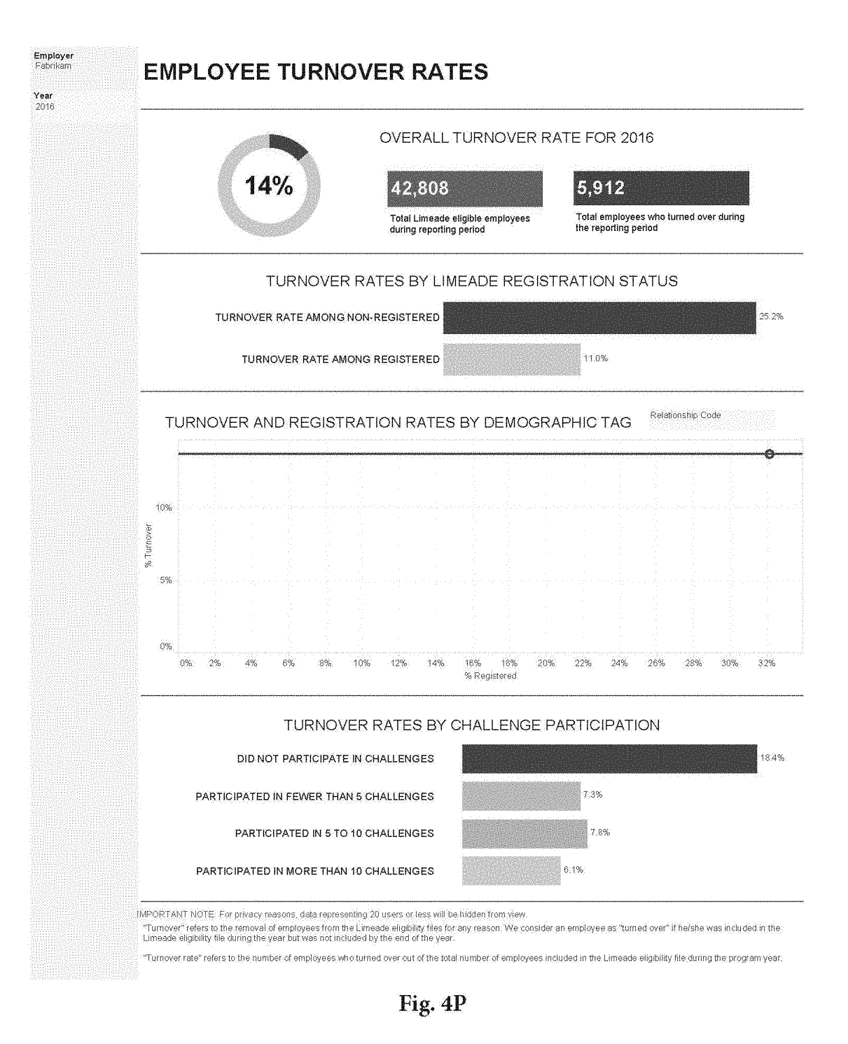

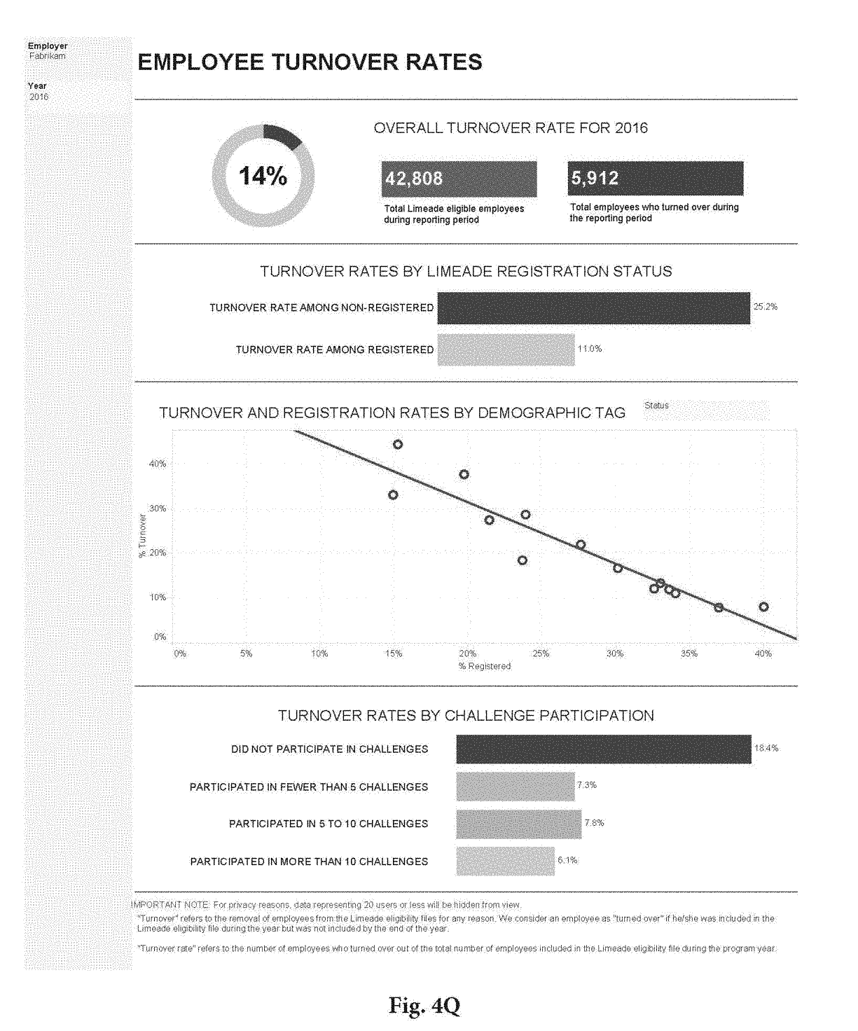

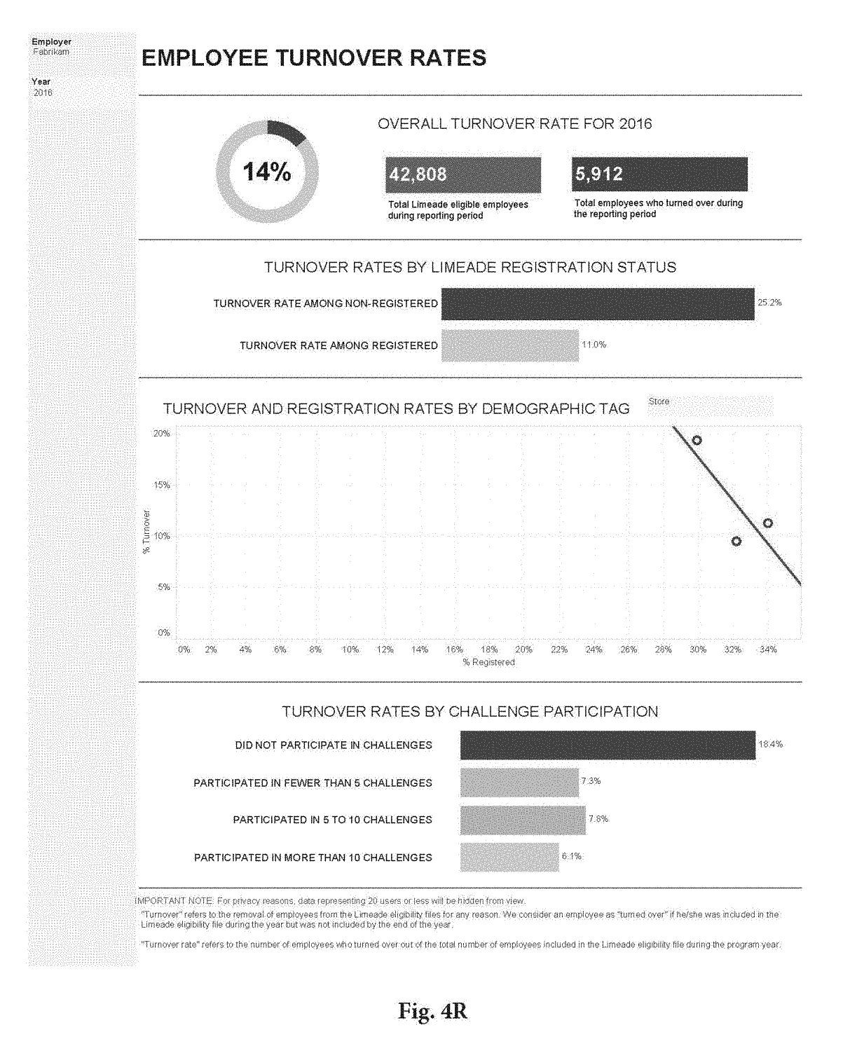

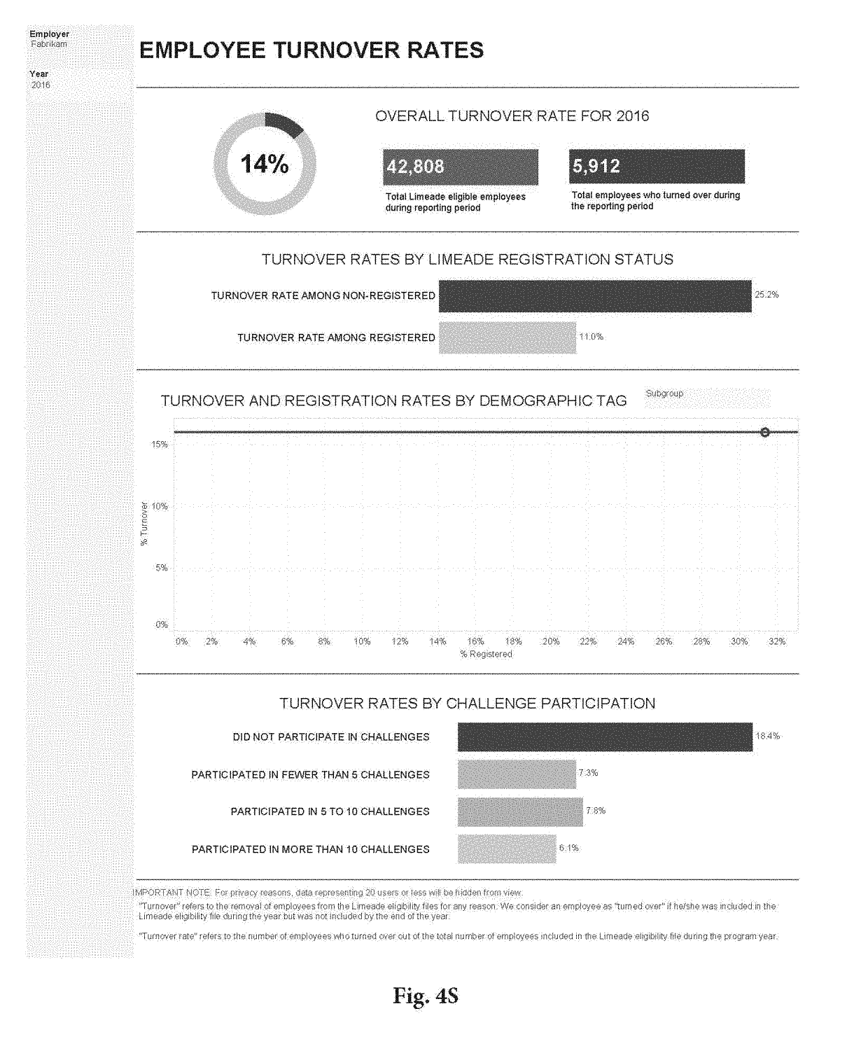

FIGS. 4A through 4S illustrate one embodiment of the Dashboard, as similarly described above in reference to FIGS. 3A-3S, for turnover information analyzed for, in this example, the Limeade company over year 2016.

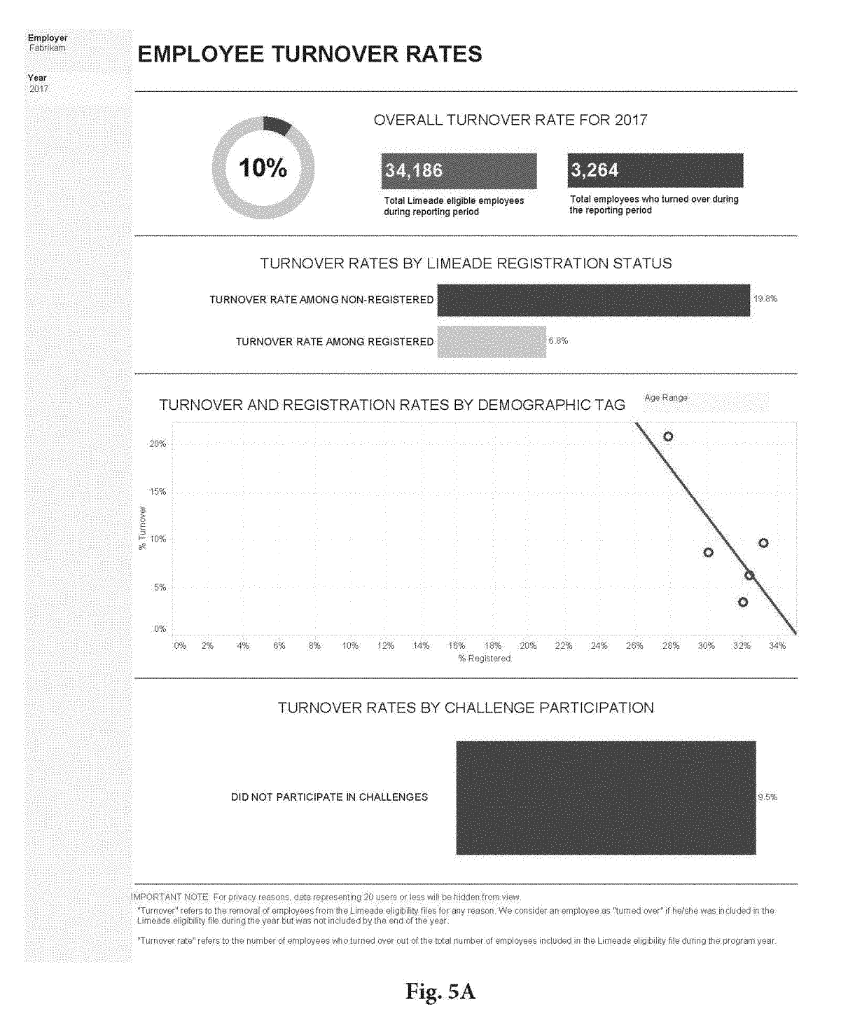

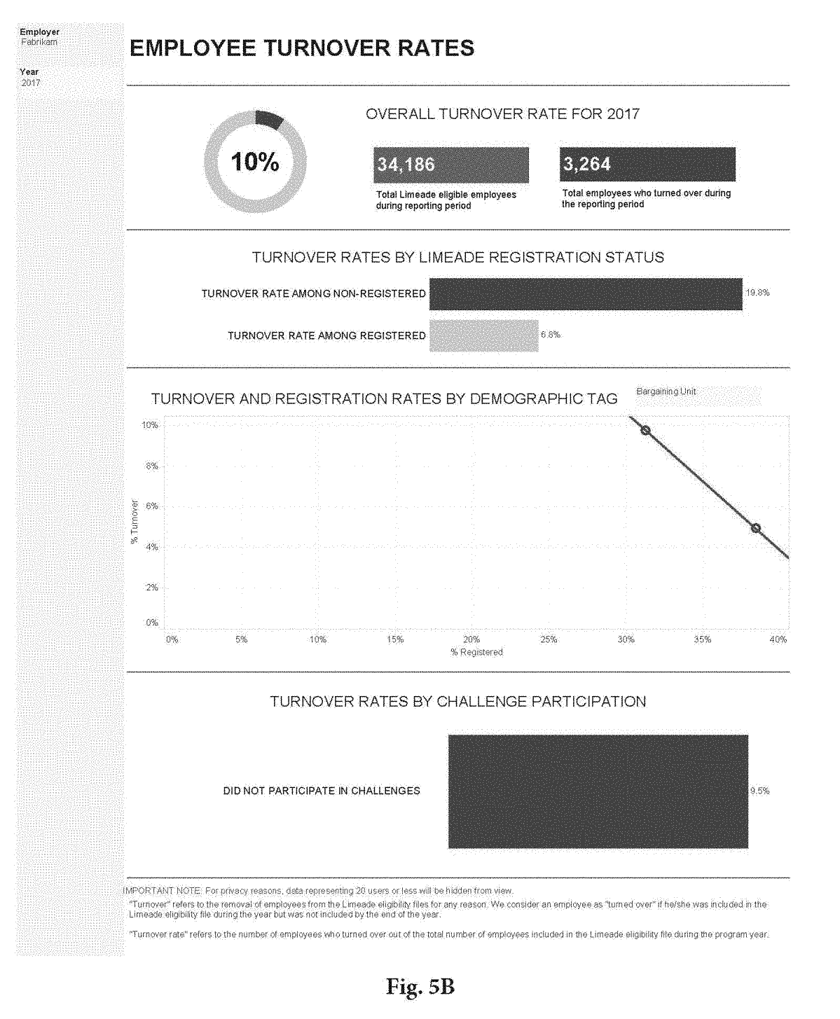

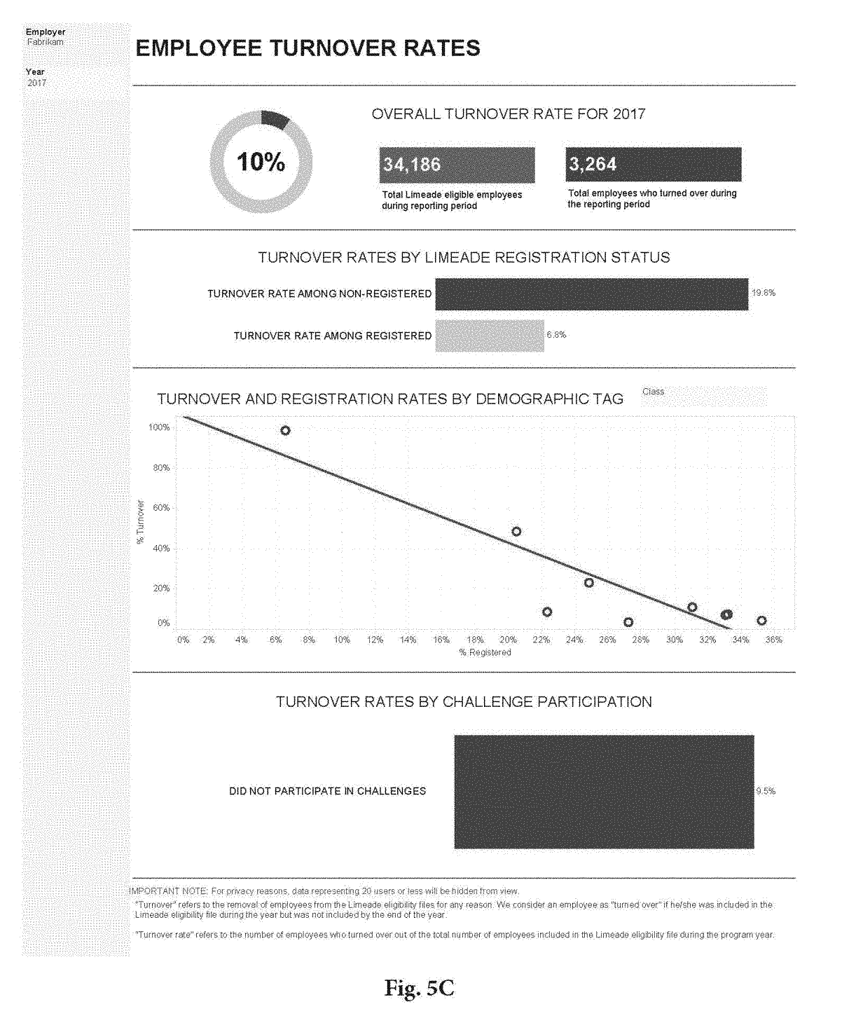

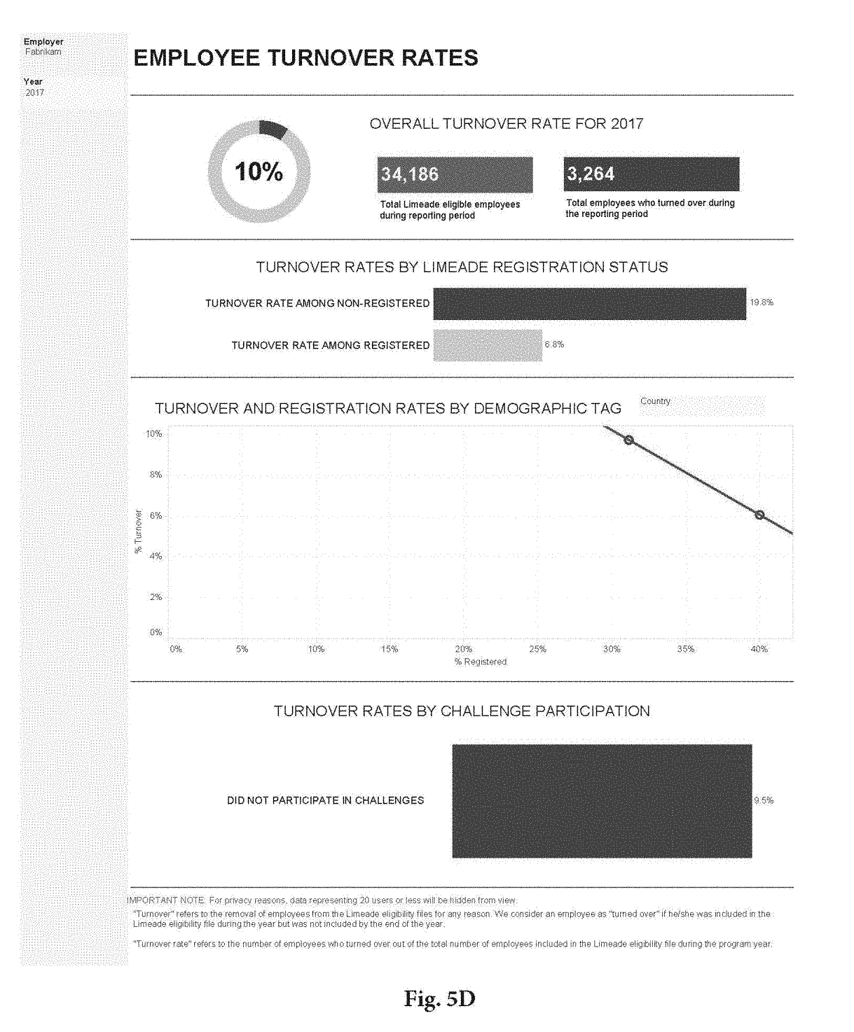

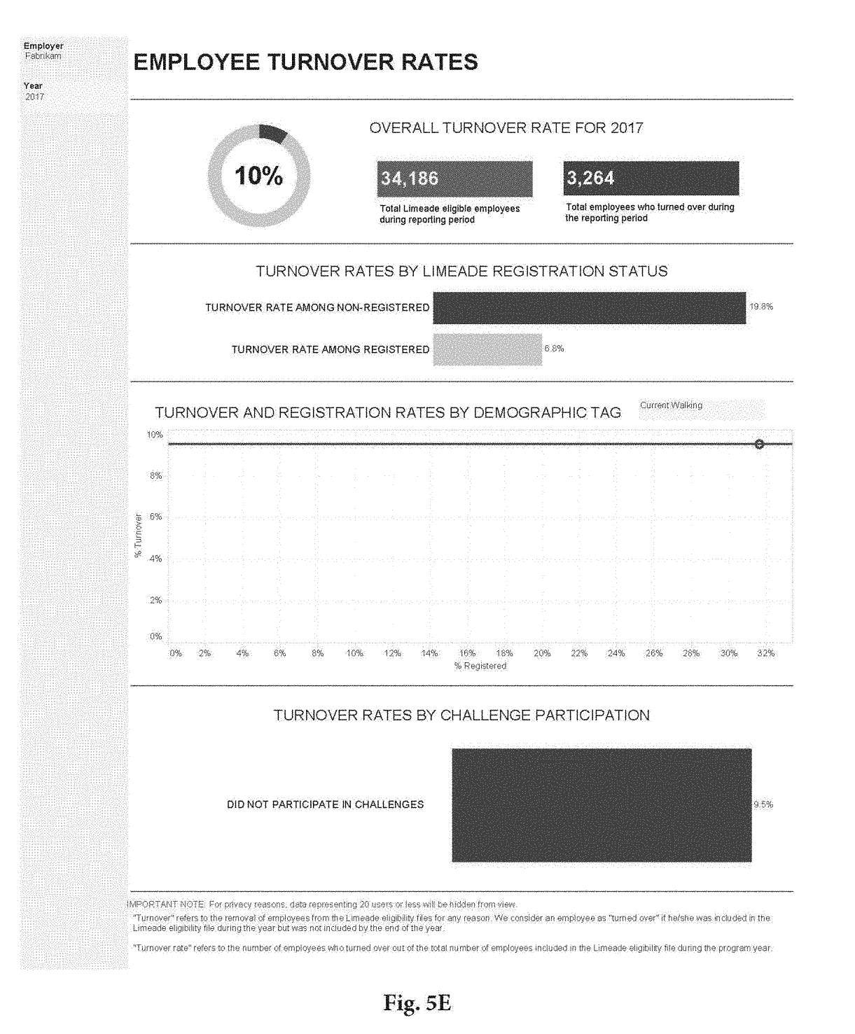

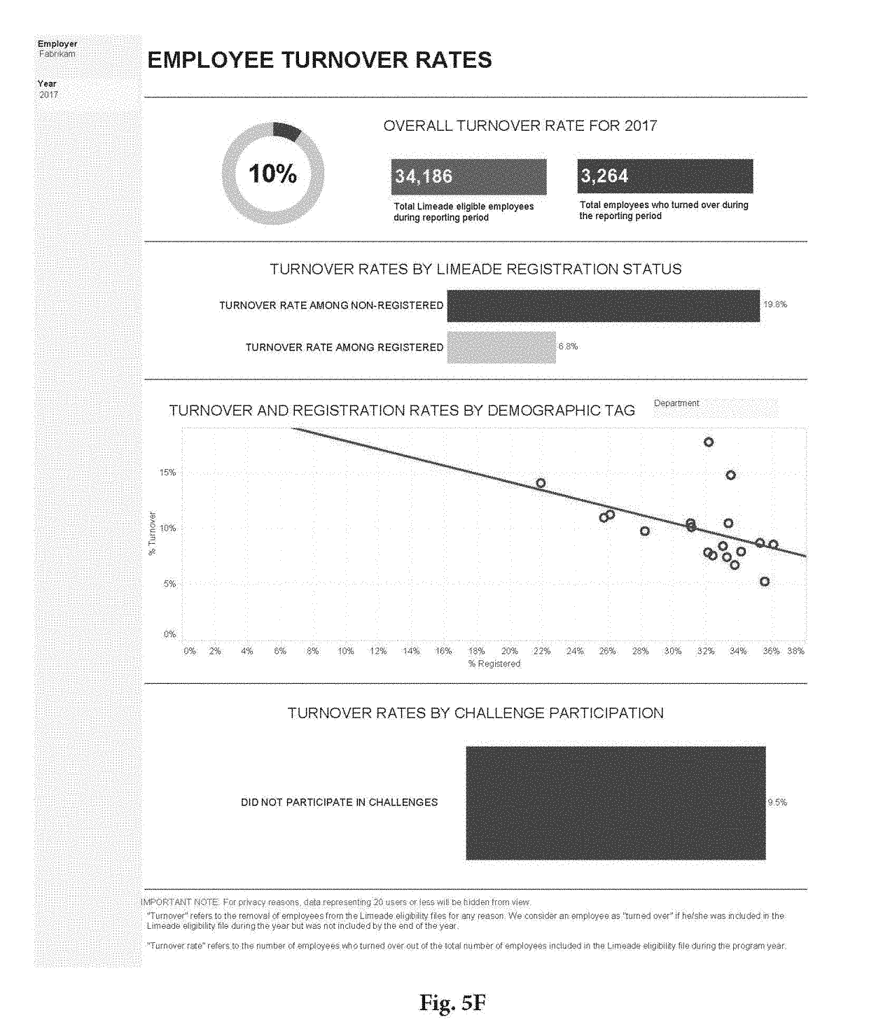

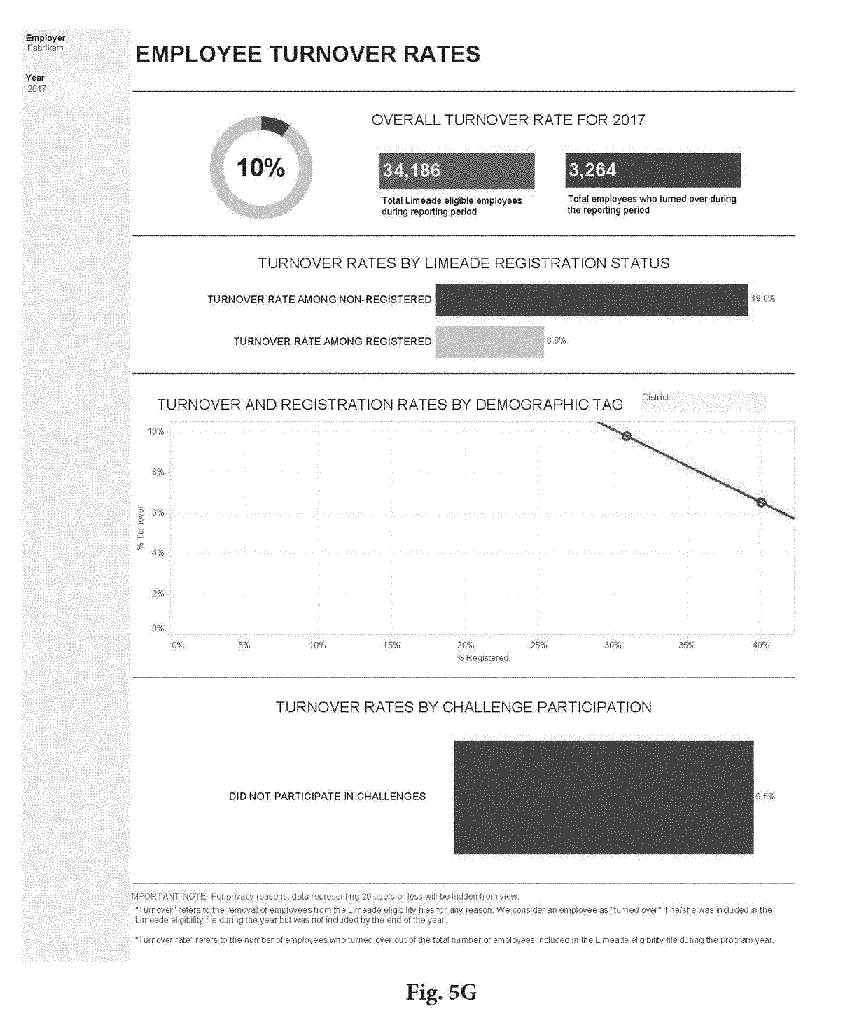

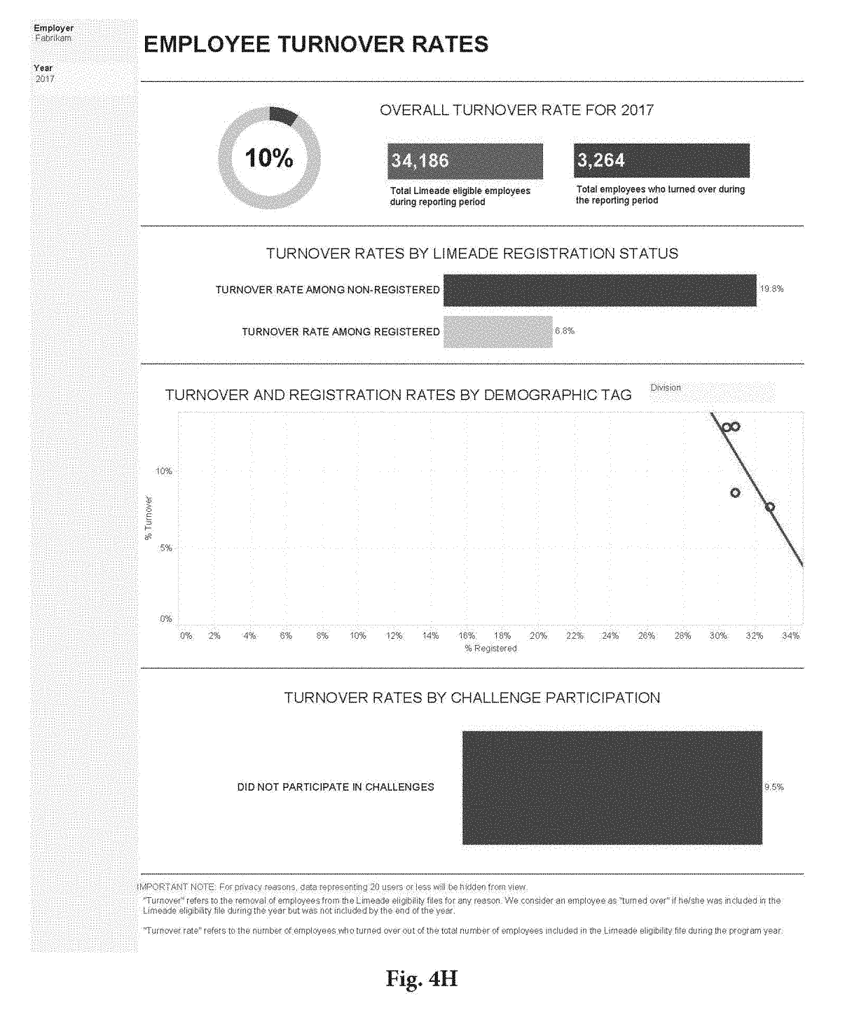

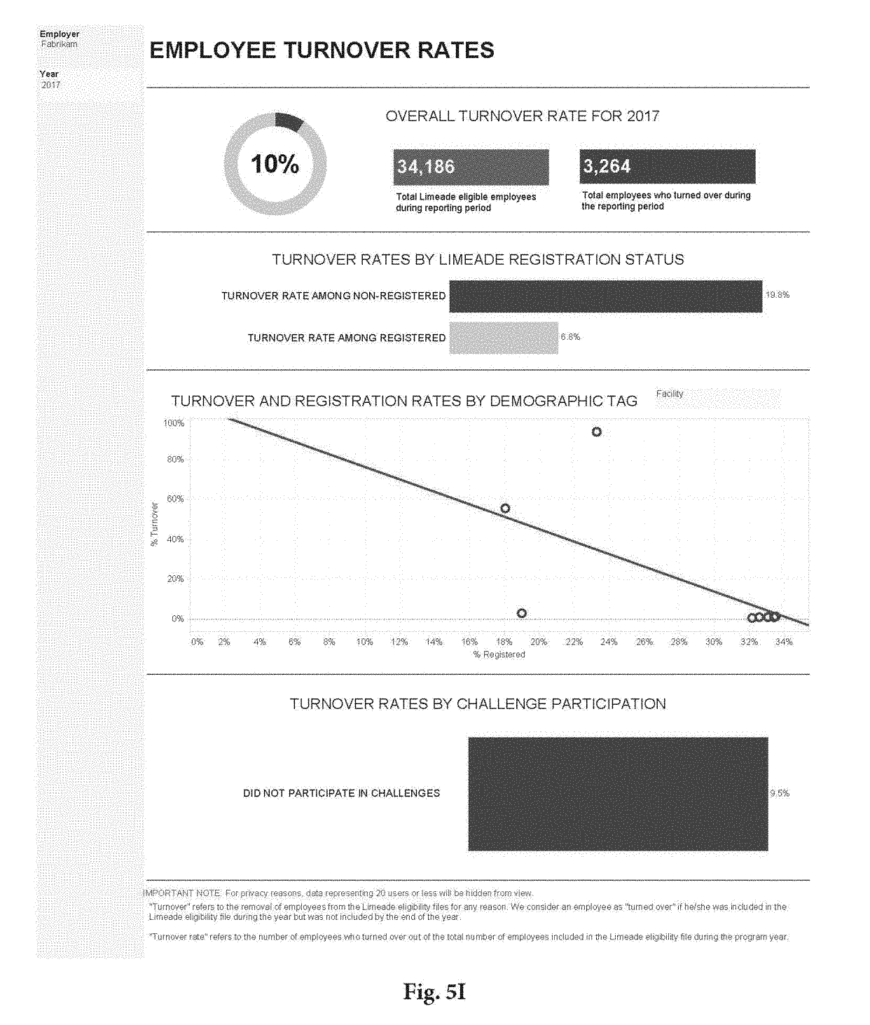

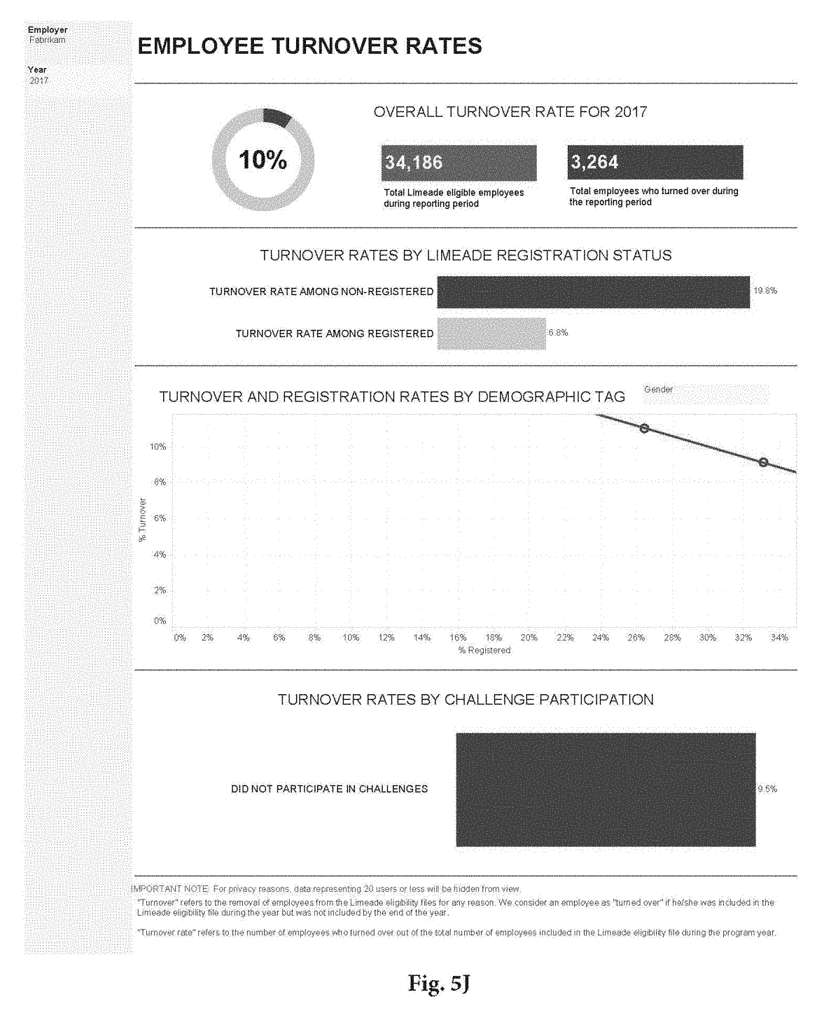

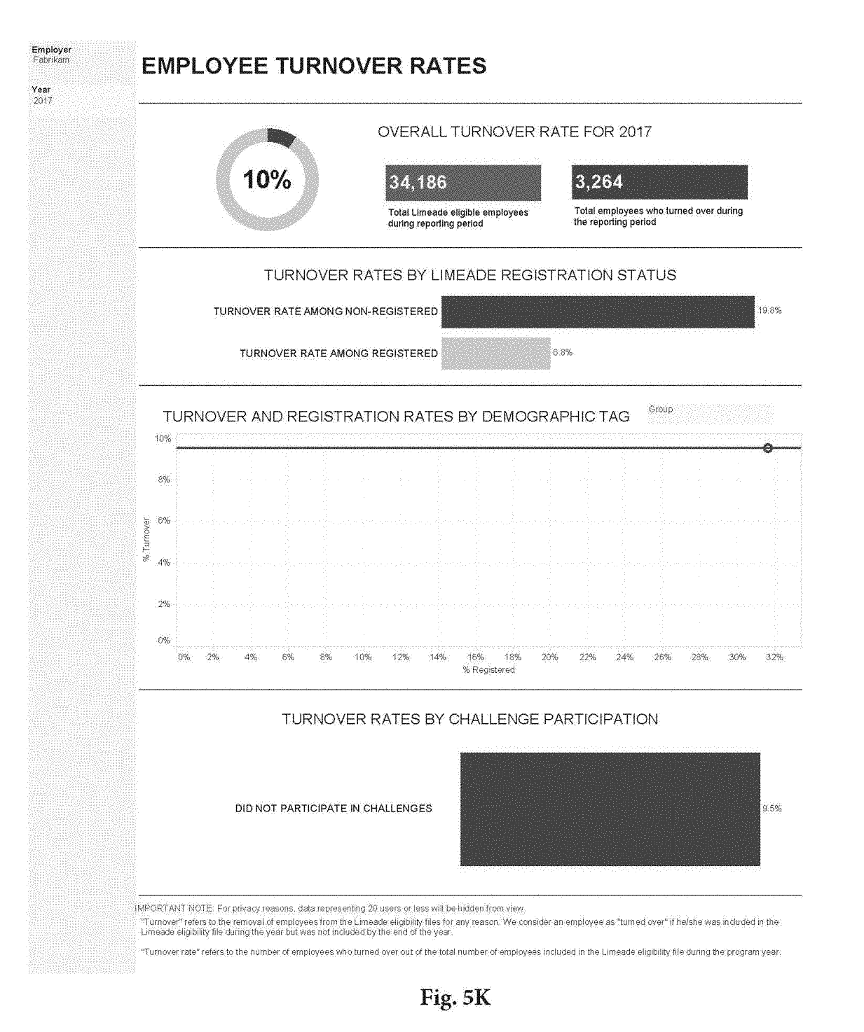

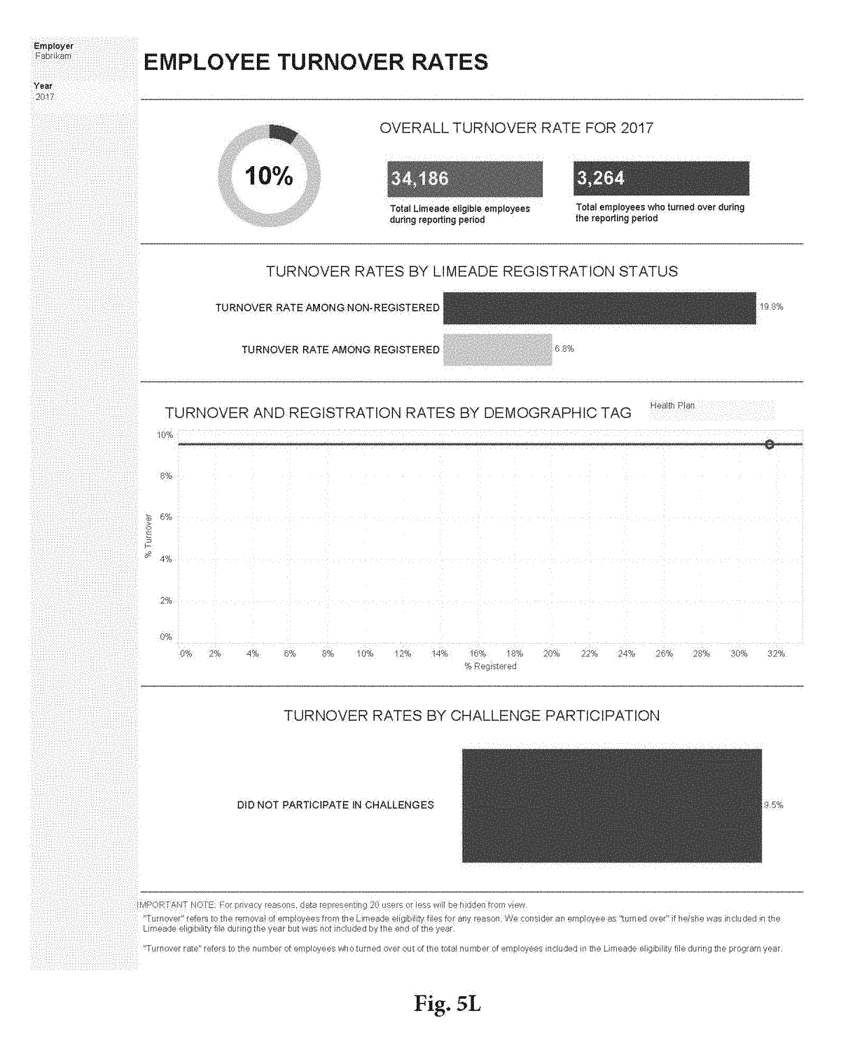

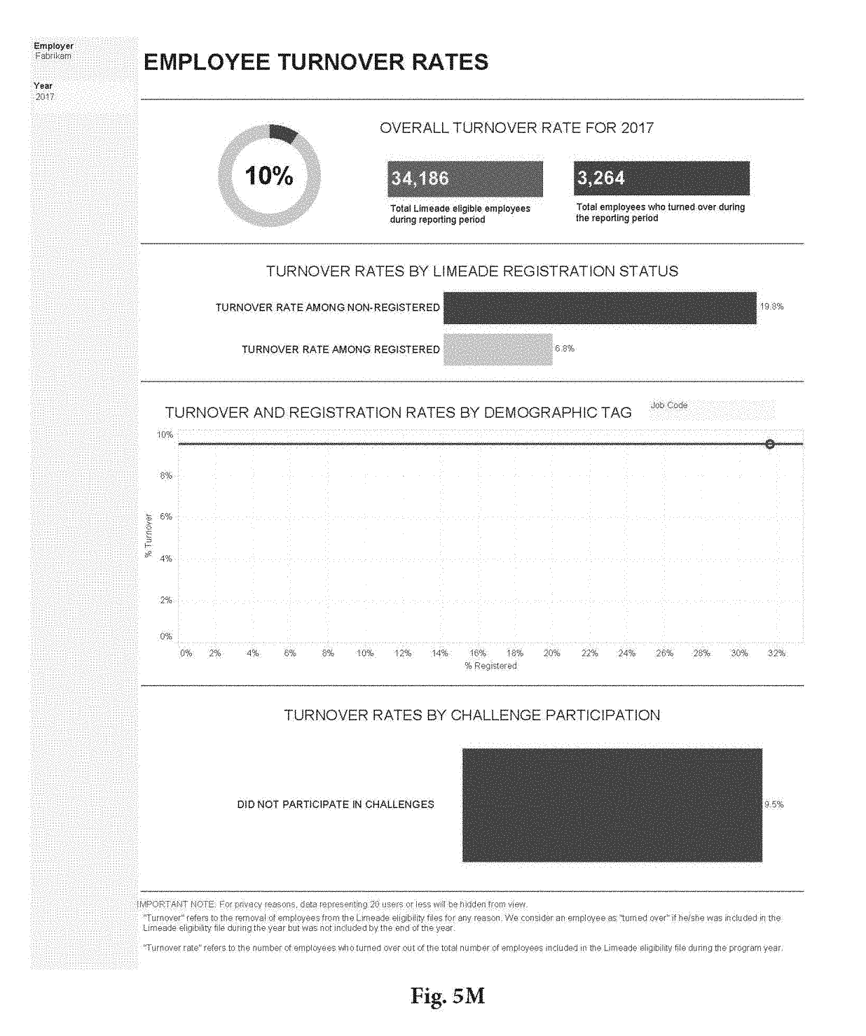

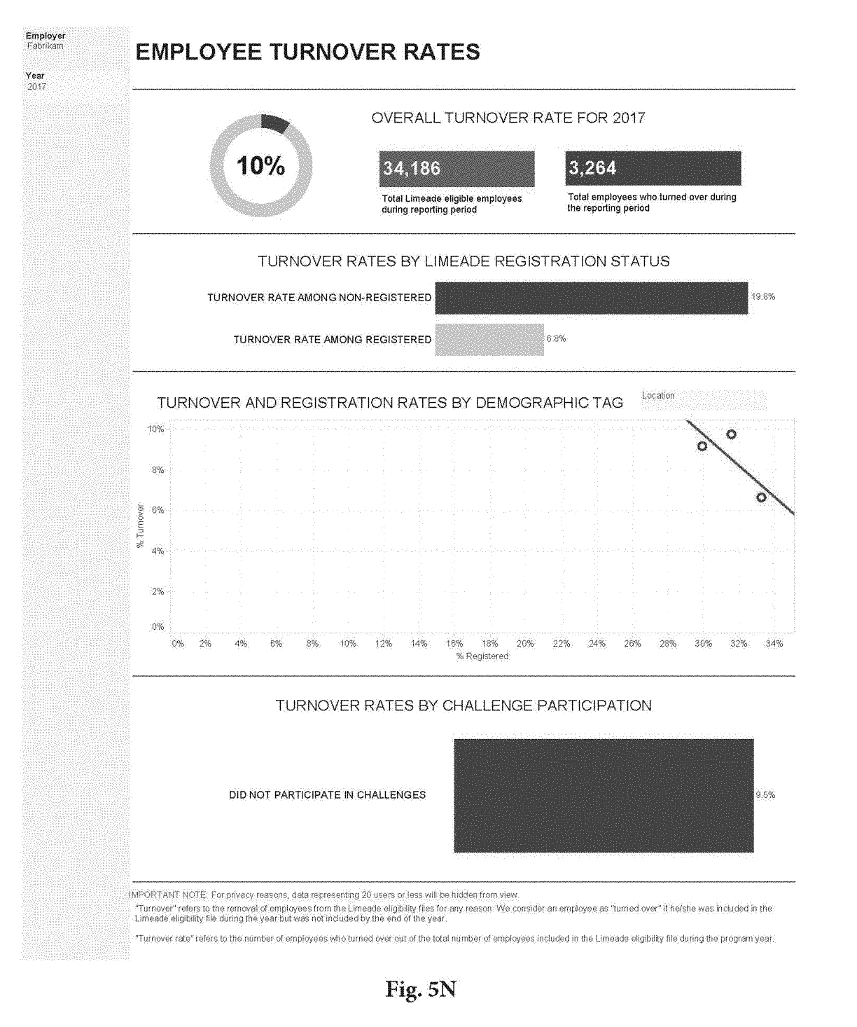

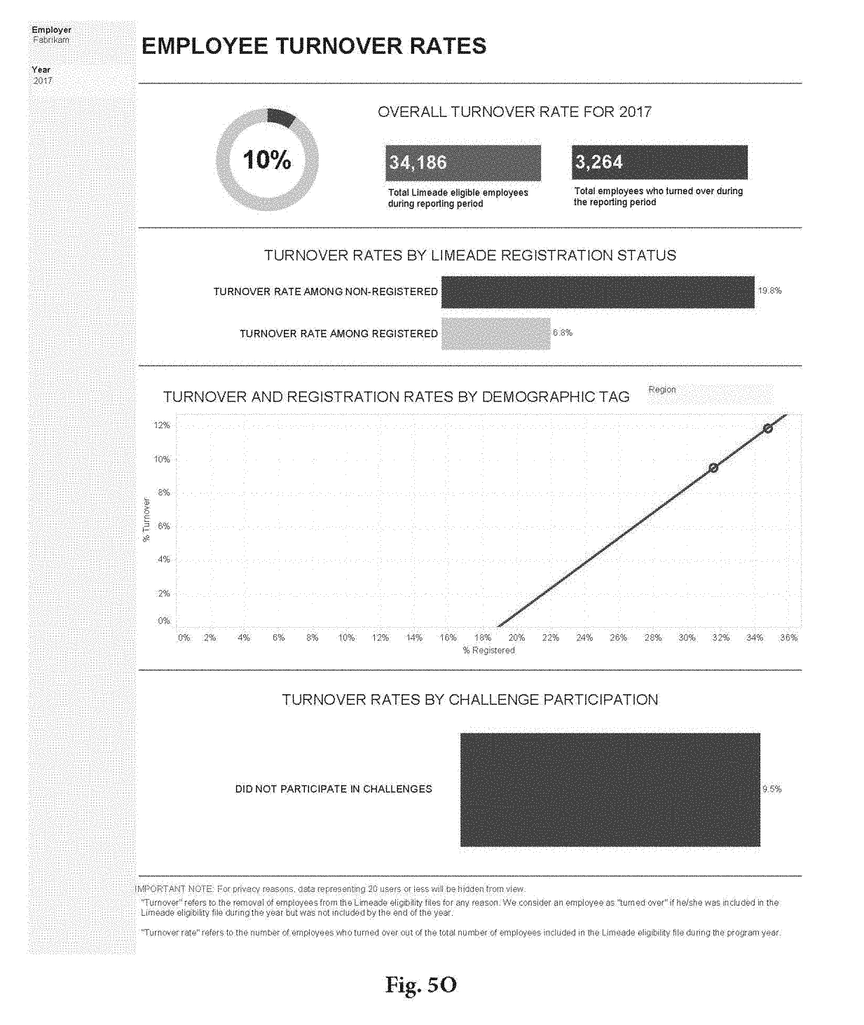

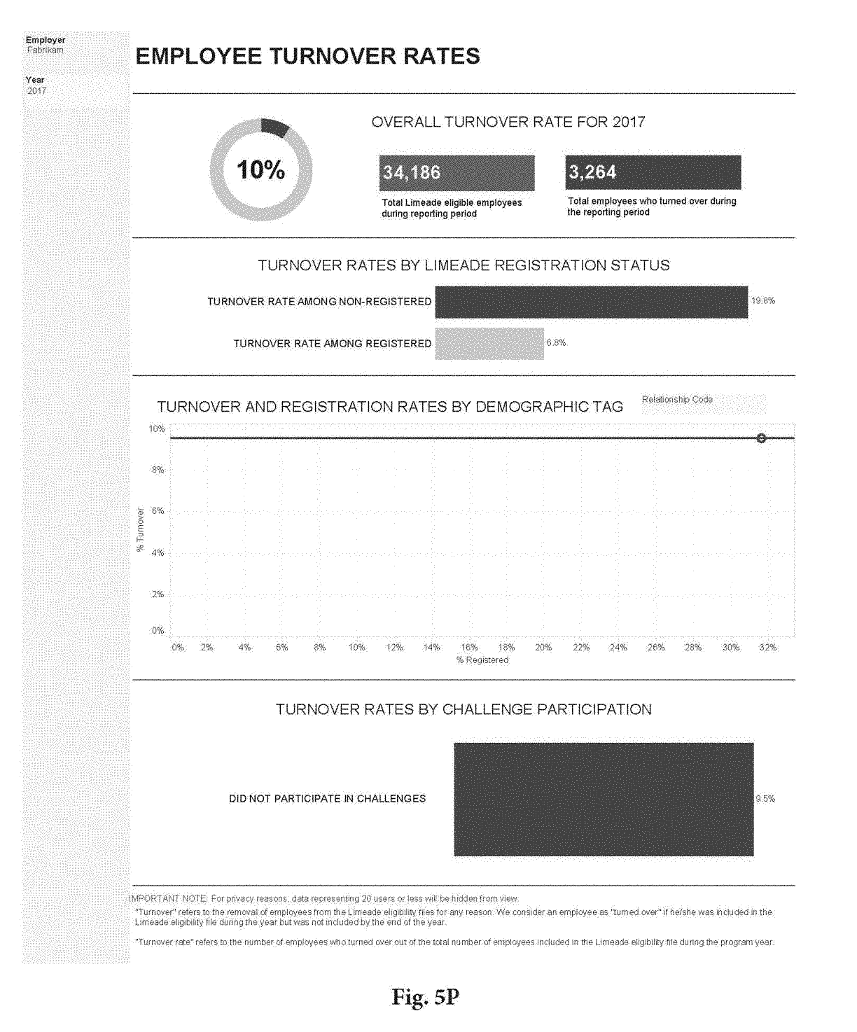

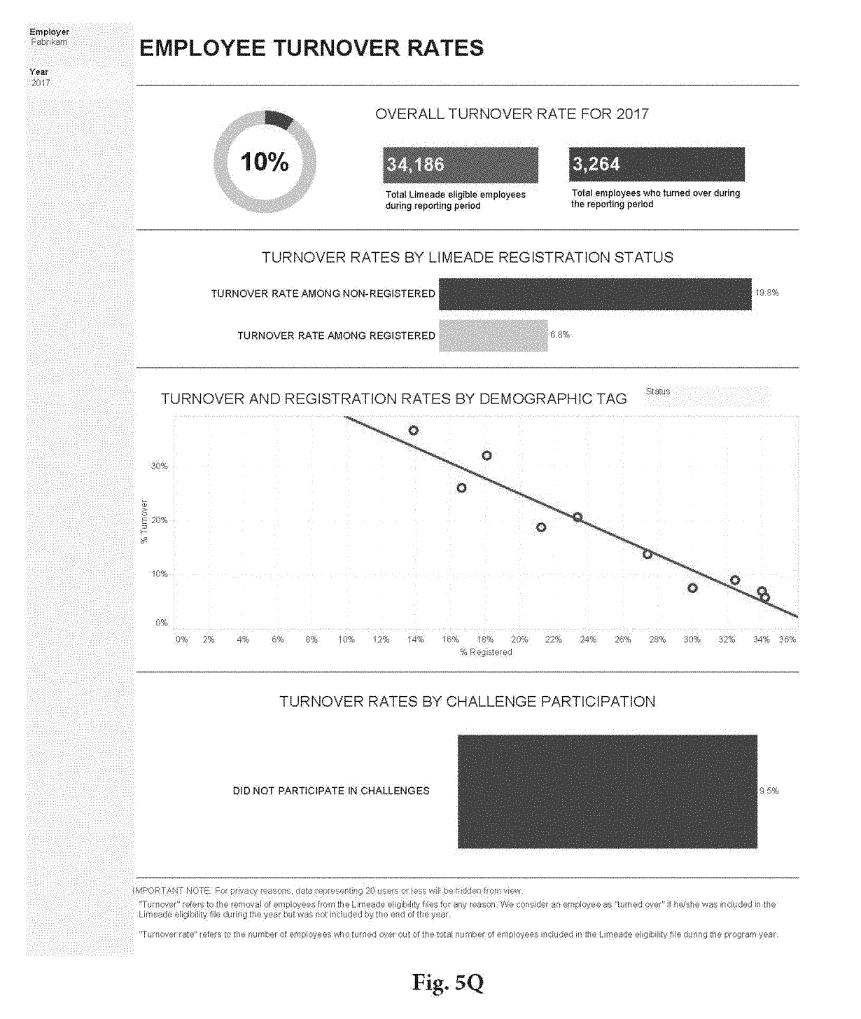

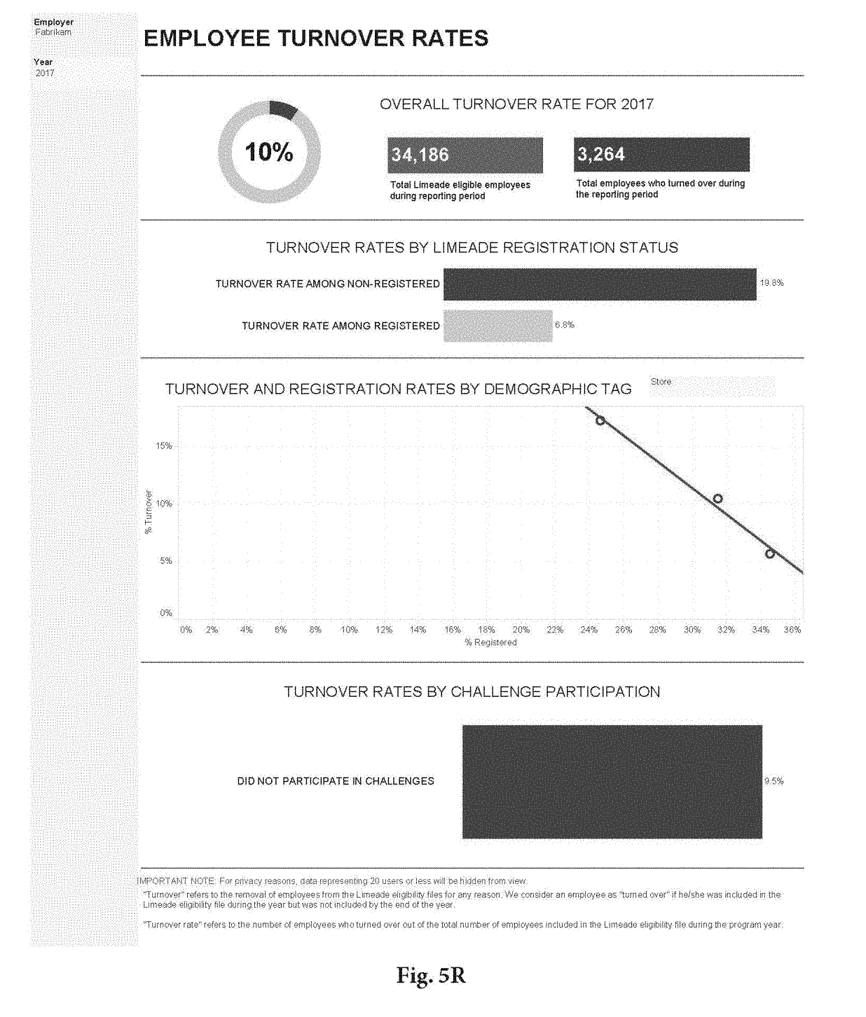

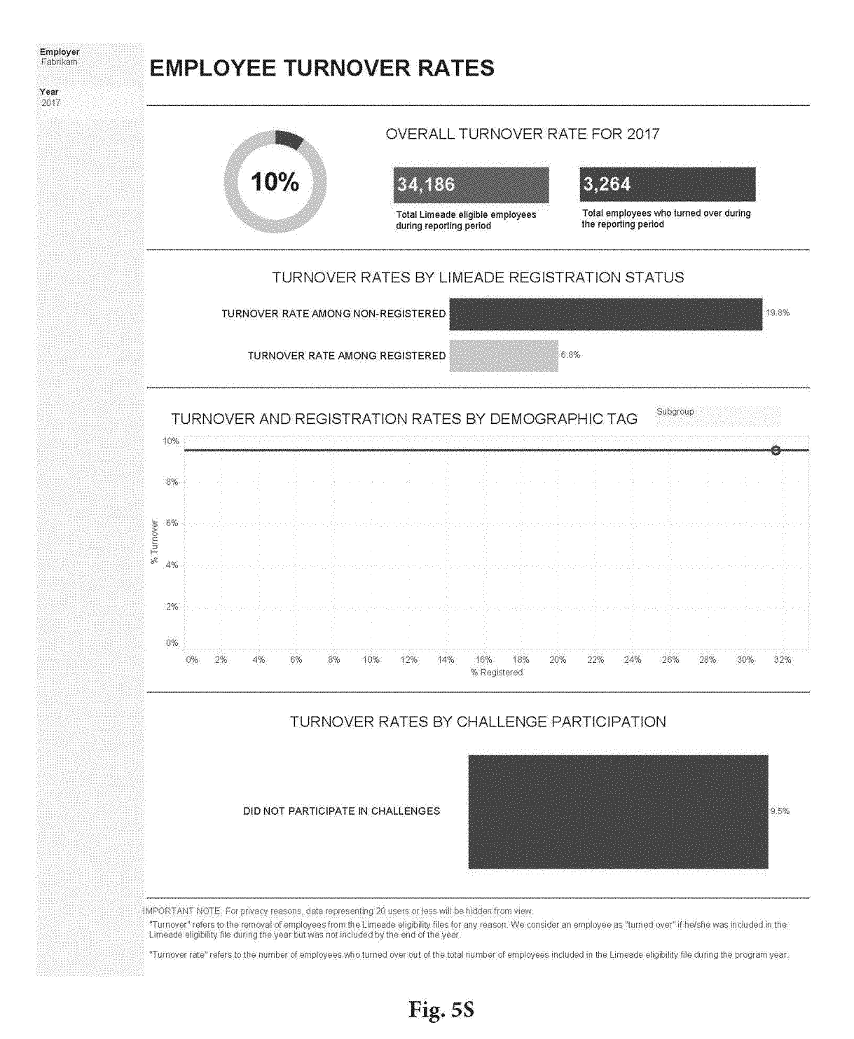

FIGS. 5A through 5S illustrate one embodiment of the Dashboard, as similarly described above in reference to FIGS. 3A-3S, for turnover information analyzed for, in this example, the Limeade company over year 2017.

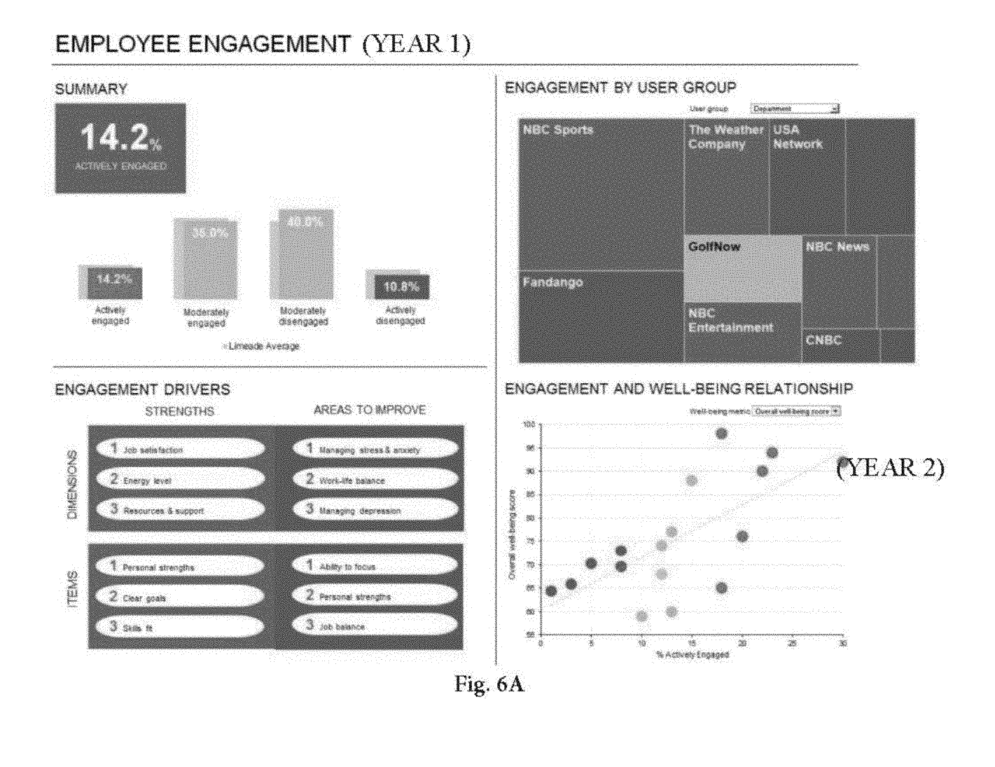

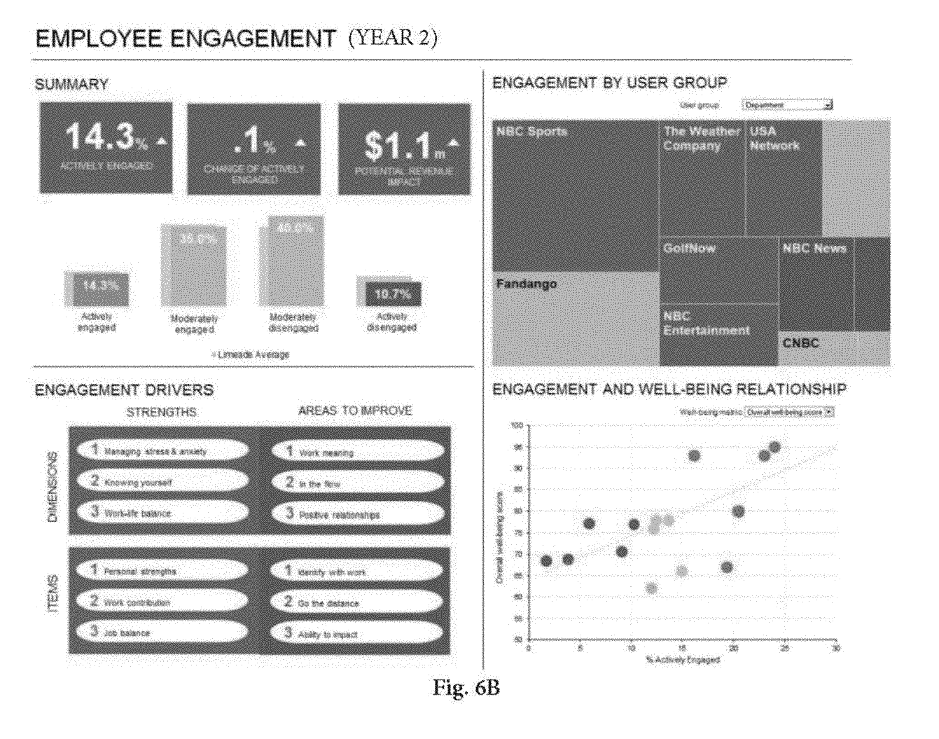

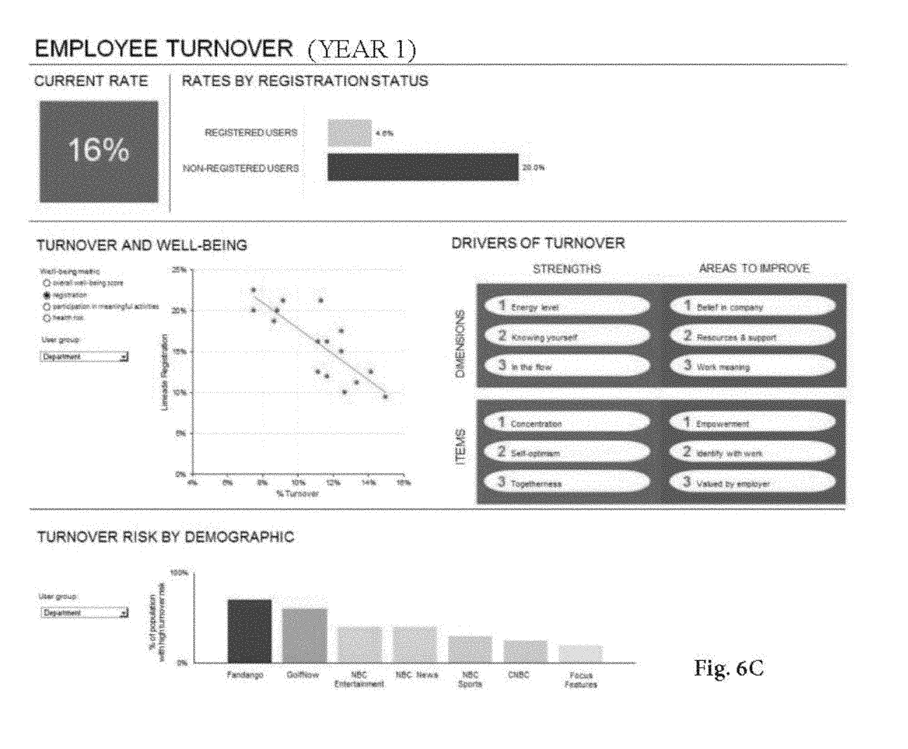

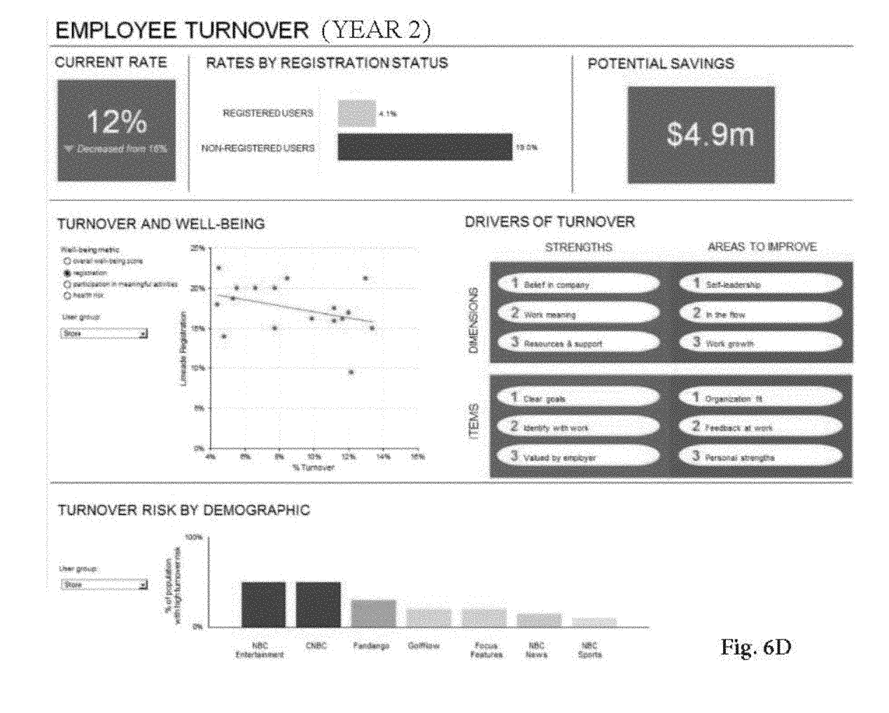

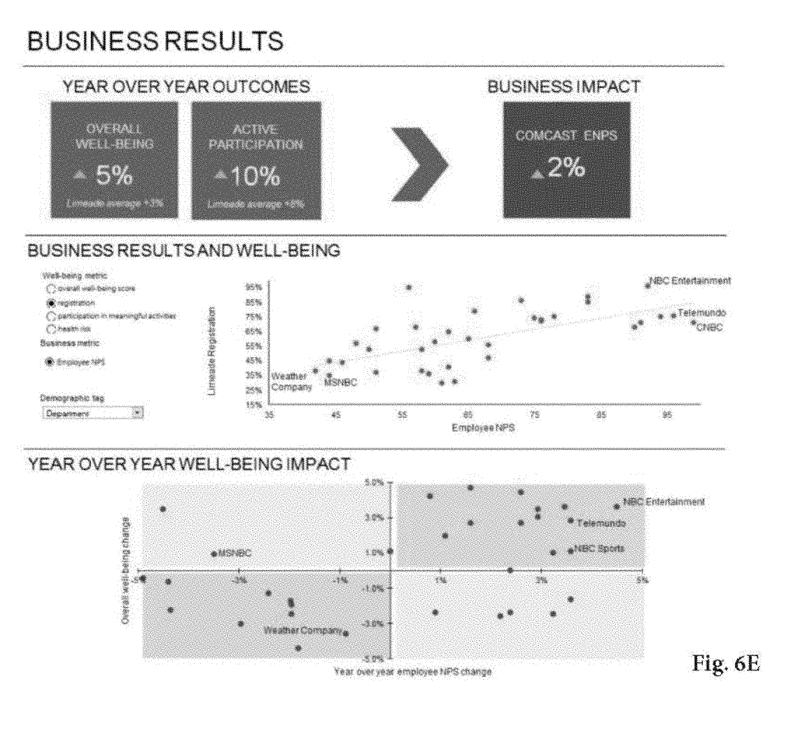

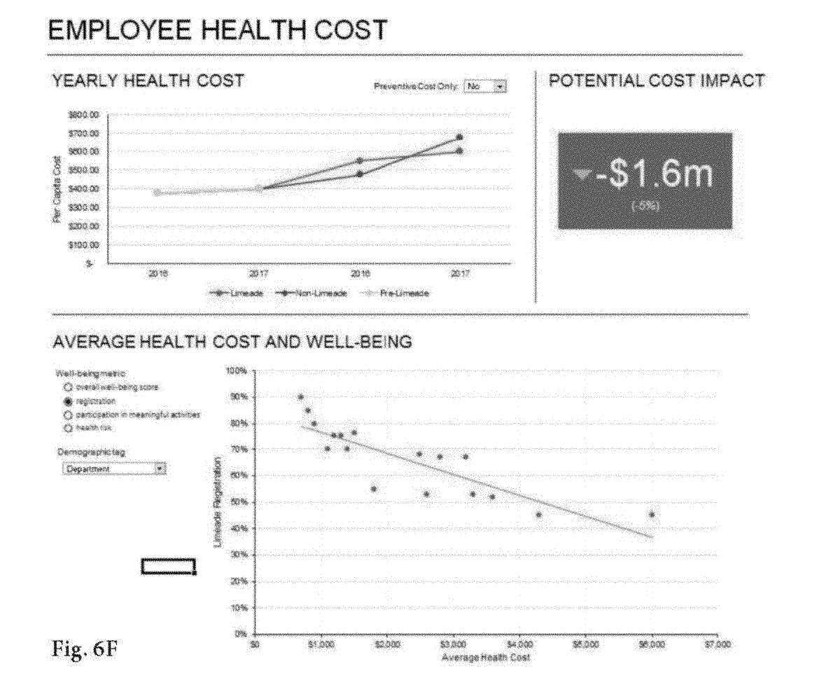

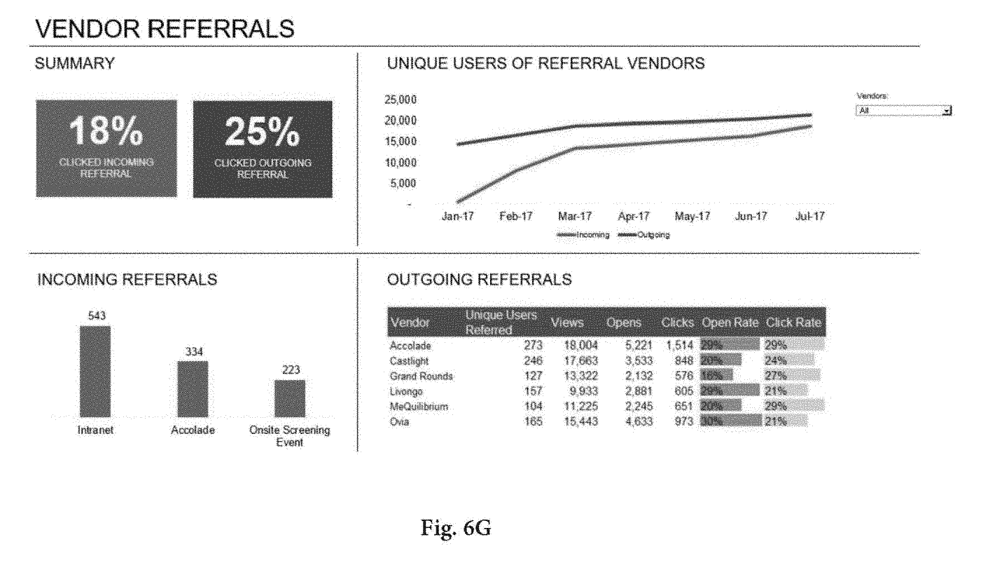

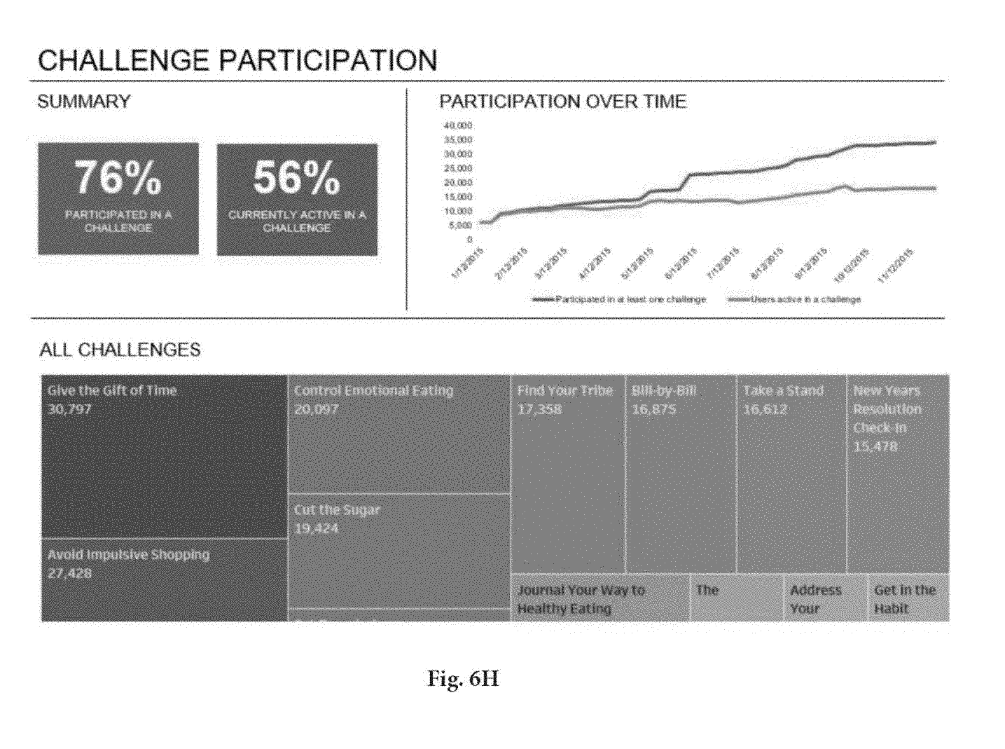

FIGS. 6A through 6H illustrate one embodiment of the Dashboard, which is included in a larger set of information analyzed for and presented to a company.

FIGS. 6A and 6B include screenshots from the engagement dashboard. This dashboard shows an overview of a company's population, focusing on engagement (based on x) and the factors identified as drivers (strengths and opportunities) in that breakdown. The dashboard also shows the relationship between actively engaged employees and their well-being scores, based on Limeade's Well-being Assessment. FIGS. 6C and 6D include representations of turnover risk demographics. This component will estimate turnover risk based on ˜50 different factors input into a machine-learning based algorithm.

FIGS. 6E-6G include other visual representations of turnover information. 6E demonstrates relationships between business results, where available, and well-being measurements. FIG. 6F demonstrates relationships between employee health expense and well-being measurements. FIG. 6G tracks click behavior for referrals. This is not directly turnover-dashboard related.

FIG. 6H includes a screenshot from part of a challenge participation dashboard. This represents individual challenges/activities in an employer program and is not directly turnover-dashboard related.

While the preferred embodiment of the invention has been illustrated and described, as noted above, many changes can be made without departing from the spirit and scope of the invention. Accordingly, the scope of the described systems and techniques is not limited by the invention of the preferred embodiment. Instead, the described systems and techniques should be determined entirely by reference to the claims that follow.

We claim:

1. A method comprising the steps:
using employee well-being program data to indicate and predict employee turnover.

2. A method comprising the steps:
inputting employee well-being program data;
monitoring changes in employee employment status data;
analyzing the correlation between well-being program data and changes in employee employment status data using an extreme gradient boosting prediction model; and
displaying analysis as an interactive report.

3. A system comprising:
a computational unit which receives employee well-being program data and analyzes the employee well-being program data to indicate and predict employee turnover.

4. A system comprising:
a computational unit that receives employee well-being program data and employee participation eligibility data, wherein the employee participation eligibility data is monitored for changes;
an algorithm that models the correlation between well-being program data and changes in employee participation eligibility data; and
a dashboard which displays the correlation as an interactive report.
